(19) United States
(12) Patent Application Publication
(10) Pub. No.: US 2014/0047004 A1
(43) Pub. Date: Feb. 13, 2014

(54) Community service reconciliation system

(71) Applicants: Brian R. Anglin, Del Mar, CA (US); Richard L. Anglin, JR., Del Mar, CA (US)

(72) Inventors: Brian R. Anglin, Del Mar, CA (US); Richard L. Anglin, JR., Del Mar, CA (US)

(21) Appl. No.: 13/573,027

(22) Filed: Aug. 13, 2012

(51) Int. Cl. G06F 15/16

(52) U.S. Cl. 709/203

(57) ABSTRACT

Methods and apparatus are disclosed for providing methods and apparatus for using remote server, a Web site and information appliances to match community service organizations that are looking for volunteers to students looking for opportunities to engage in community service.

### INTRODUCTION

The title of this Non-Provisional patent application is Community Service Reconciliation System. The Applicants are Brian R. Anglin, 2115 Heather Lane, Del Mar, Calif. 92014-2244, and Richard L. Anglin, Jr., 2115 Heather Lane, Del Mar, Calif. 92014-2244. Both Messrs. Anglin are Citizens of the United States of America.

### CROSS-REFERENCE TO A RELATED PENDING PATENT APPLICATIONS & CLAIMS FOR PRIORITY

None.

### FIELD OF THE INVENTION

One embodiment of the present invention pertains to methods and apparatus for using remote server, a Web site and information appliances to match community service organizations that are looking for volunteers to students looking for opportunities to engage in community service.

### FEDERALLY SPONSORED RESEARCH OR DEVELOPMENT

None.

### BACKGROUND OF THE INVENTION

According to the Web site Volunteers in America, 62.8 million adults in the United States volunteered over eight billion hours of their time to local and national organizations in 2010. The total value of these services exceeded an estimated $170 billion.

The current marketplace does not provide an easy-to-use, effective and comprehensive system for matching community service organizations to volunteers.

The development of such a system would constitute a major technological advance, and would satisfy long felt needs and aspirations in the field of community service.

### SUMMARY OF THE INVENTION

In one embodiment of the Community Service Reconciliation System, community service organizations (“CSOs”) that are looking for volunteers are matched with students who must engage in community service activities to meet school or other student organization requirements. The most preferred embodiment of the matching means is a Web site. CSOs list events for which they seek volunteers. Students search available events and register to participate in them.

In one embodiment, the Web site runs on a remote server, which includes a remote server memory. The Web site is generated by a software program that is stored and which operates on the remote server. A user may view and then log on to the Web site using a variety of information appliances, including, but not limited to, a personal computer, a Smart Phone, a smart television, a laptop computer, a tablet computer or any other device that is suitable for using a Web site. The information appliance includes an information appliance memory.

When the user logs on to the Web site and supplies information that updates the Web site, the updated information is stored in the memory of the remote server. The memory of the remote server is transformed, and changes its state. When the user operates his or her information appliance by viewing or updating the Web site, the memory of the information appliance is transformed, and changes its state.

An appreciation of the other aims and objectives of the present invention and a more complete and comprehensive understanding of this invention may be obtained by studying the following description of a preferred embodiment, and by referring to the accompanying drawings.

### A BRIEF DESCRIPTION OF THE DRAWINGS

FIG. 1 shows one embodiment of the Community Service Reconciliation System in which a user uses an information appliance to communicate with a remote server via a communications network.

FIG. 2 shows embodiments of an information appliance comprising a processor, memory and a software application.

FIG. 3 shows embodiments of a communications network.

FIG. 4 shows a user sending data from an information appliance to a remote server via a communications network.

FIG. 5 shows a remote server sending data via a communications network to a user's information appliance.

FIG. 6 shows a preferred embodiment of the Community Service Reconciliation System in which the users are students, community service organizations, and schools.

FIG. 7 shows a system for matching community service organizations that are looking for volunteers to students looking for opportunities to engage in community service.

FIG. 8 shows the most preferred embodiment of the matching means for students looking for opportunities to engage in community service, a Web site.

FIG. 9 shows transformations and changed states of information appliances and a remote server as evidenced by alterations in any display or interface of an information appliance.

FIG. 10 shows a first Web site screen through which representatives of community service organizations, students and school representatives may login or register.

FIG. 11 shows a community service organization registration popup box.

FIG. 12 shows a student registration popup box.

FIG. 13 shows a school registration popup box.

FIG. 14 shows a community service organization home page.

FIG. 15 shows a community service organization event popup box.

FIG. 16 shows a community service organization event popup box showing the type of event.

FIG. 17 shows a community service organization popup box that shows the status of student participation in an event.

FIG. 18 shows a community service event evaluation form popup box.

FIG. 19 shows a school home page.

FIG. 20 shows a message to a student.

FIG. 21 shows a search by class popup box.

FIG. 22 shows a search by student popup box.

FIG. 23 shows a search by community service organization popup box.

FIG. 24 shows a search by event popup box.

FIG. 25 shows a popup box showing students registered in a school that are not registeed on the Web site.

FIG. 26 shows a message from a school containing a link to the student registration Web site page.

FIG. 27 shows a student home page.

FIG. 28 shows a community service event description popup box.

FIG. 29 shows a community service event registration popup box.

FIG. 30 shows a community service events for which a student's friends have already registered popup box.

FIG. 31 shows a community service event unregistration popup box.

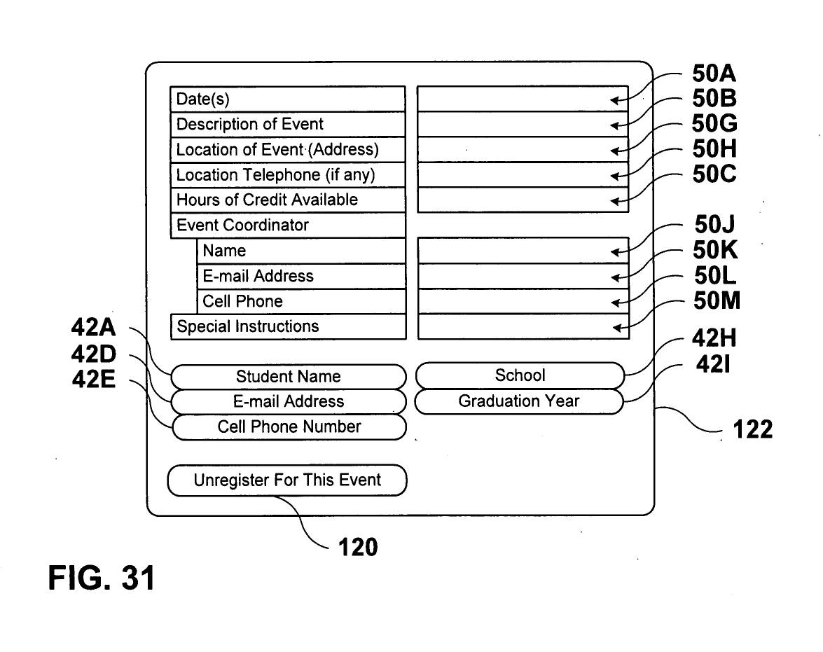

FIG. 32 shows a search popup box.

FIG. 33 shows search results popup boxes.

FIG. 34 shows a first Web site screen through which representatives of community service organizations, students, school representatives and parents may login or register.

FIG. 35 shows a community service event evaluation form popup box that includes a student rating of the event.

FIG. 36 shows a community service organization popup box that shows the status of student participation in an event, including student ratings of the event.

FIG. 37 shows a community service event registration reservation system.

FIG. 38 shows messages to students about whether or not their registration for a community service event has been accepted.

FIG. 39 shows a popup box through which a student may enter information about a community service event not sponsored by a community service organization registered on a Web site.

FIG. 40 shows advertisements on a community service organization home page.

FIG. 41 shows a community service organization event popup box with a button to solicit sponsorship of the event.

FIG. 42 shows a student's home page with a community service goals button.

FIG. 43 shows a community service goal setting popup box.

FIG. 44 shows messages to students about their community service goals.

FIG. 45 shows a student's home page reflecting community service achievement.

FIG. 46 shows message to students or their schools about community service achievement.

FIG. 47 shows an embodiment of an intelligent match system.

FIG. 48 shows an alternative embodiment of the student registration page requesting rankings of student interests, extracurricular activities and prior community service events.

FIG. 49 shows a further preferred embodiment of the Community Service Reconciliation System in which the information on the Web site is contained in an application that may be downloaded into an information application.

FIG. 50 shows a display of a Community Service Reconciliation System application on a Smart Phone.

### A DETAILED DESCRIPTION OF PREFERRED & ALTERNATIVE EMBODIMENTS

### I. Community Service Reconciliation System

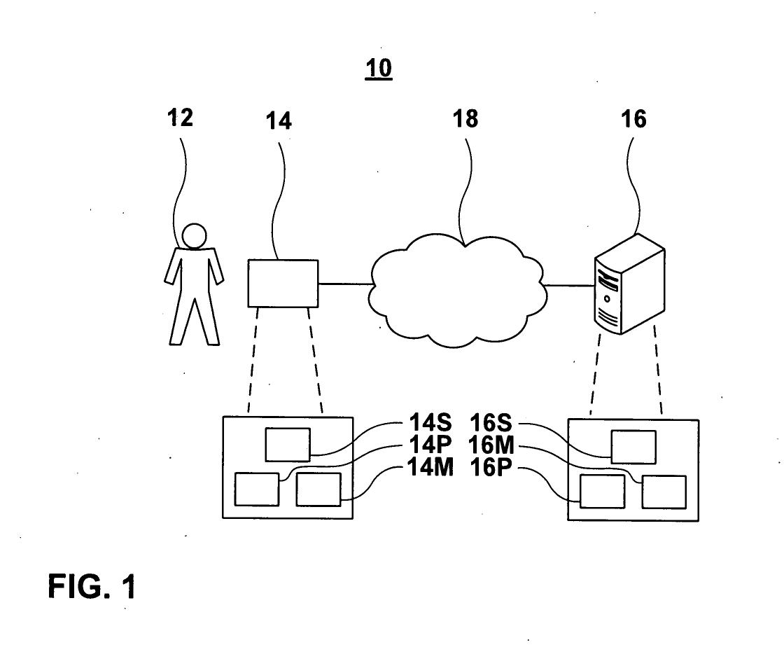

FIG. 1 depicts one embodiment of the Community Service Reconciliation System 10. Users 12 use an information appliance 14 to communicate with a remote server 16 via a communications network 18. An information appliance 14 includes a processor 14P, memory 14M, and application software 14S. A remote server comprises a processor 16P, memory 16M, and software 16S.

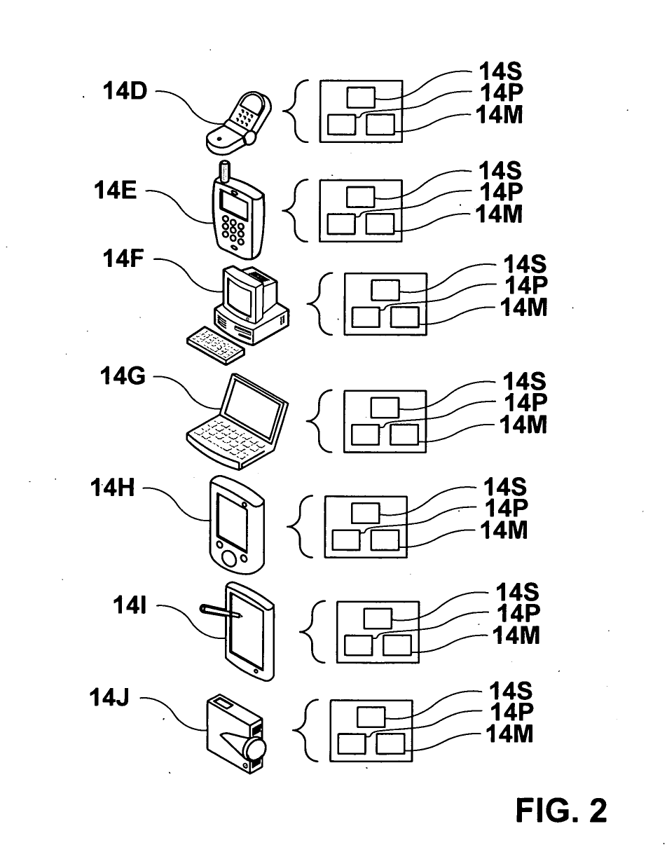

An information appliance 14 may be, but not limited to, a cell phone 14D, a Smart Phone 14E, a personal computer (“PC”) 14F, a laptop computer 14G, a Personal Digital Assistant (“PDA”) 14H, a tablet 14I, or a gaming device 14J, as shown in FIG. 2.

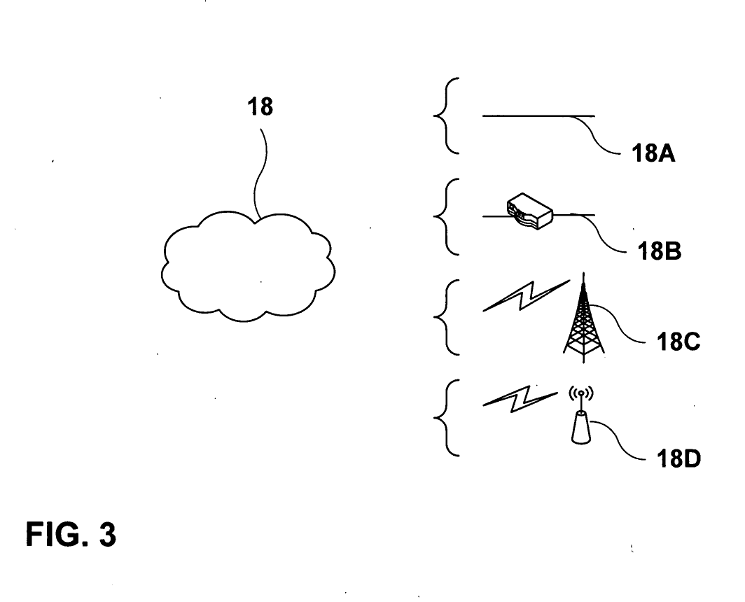

A communications network 18 includes, but is not limited to, the wired telephone network, the plain old telephone network (“POTS”) 18A, Ethernet 18B, a cellular network 18C, or Wireless Fidelity (“Wi-Fi”), Institute of Electrical and Electronics Engineers' (“IEEE”) 802.11 standards 18D, as shown in FIG. 3.

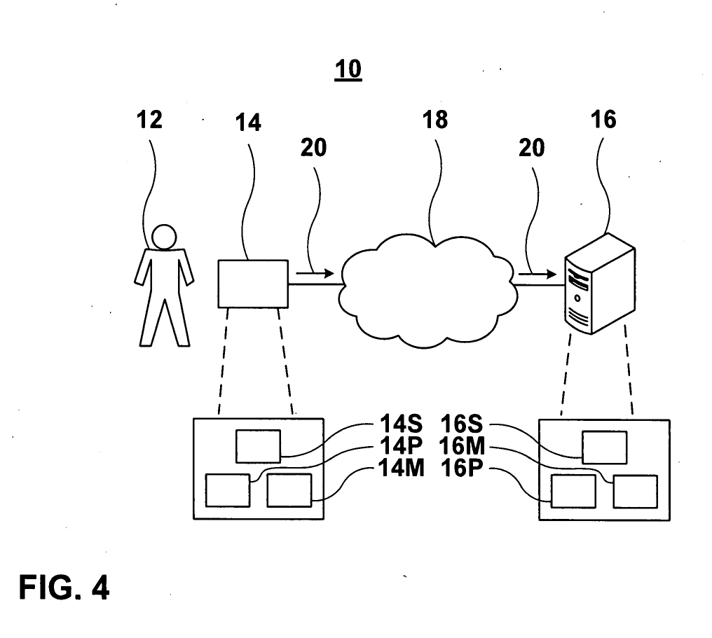

A user 12 using an information appliance 14 sends input data 20 to the remote server 16 via a communications network 18. See FIG. 4. The input data 20 transforms the memory 16M in the remote server 16, or alternatively, the memory 16M changes state based upon the input data 20.

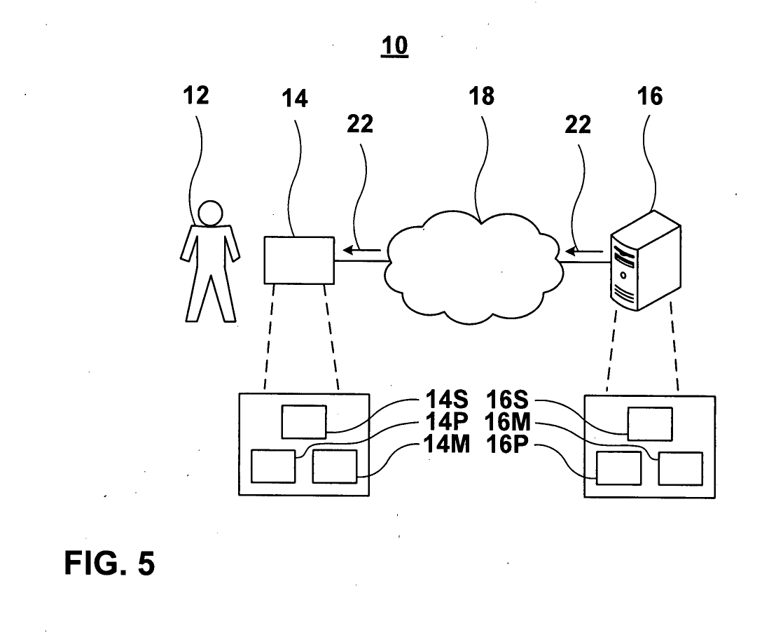

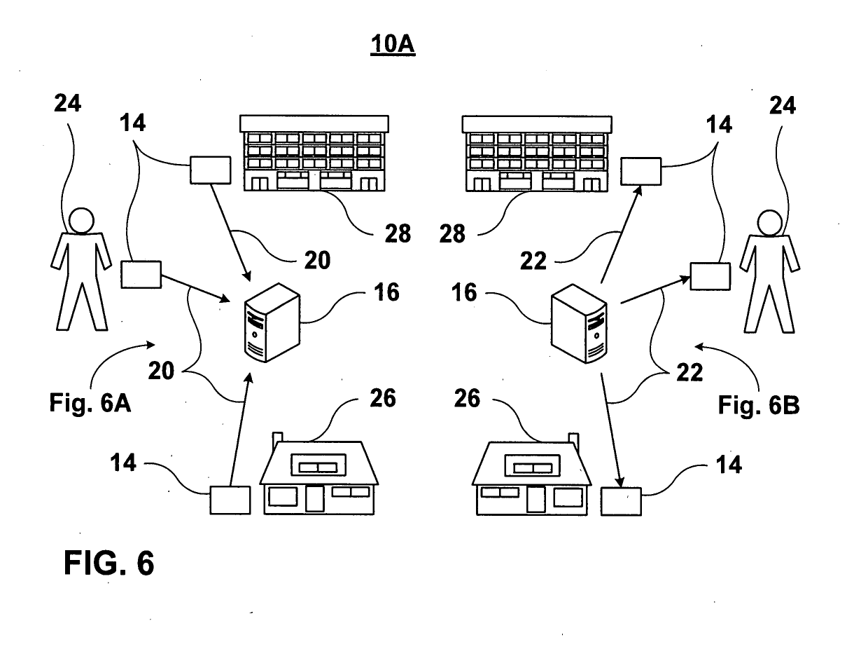

In FIG. 5 the output data 22 from the changed state or transformed remote server memory 16M is transferred back to a user's 12 information appliance 14, which, in turn, transforms the memory 14M in the information appliance 14, or alternatively, changes the state of the memory 14M in the information appliance 14. A preferred embodiment 10A of the Community Service Reconciliation System 10 shown in FIG. 6 comprises three users 12, students 24, Community Service Organizations (“CSOs”) 26, and schools 28. The instant preferred embodiment 10A of the Community Service Reconciliation System 10 is shown in FIG. 6. FIG. 6A shows students 24, CSOs 26 and schools 28 using their information appliances 14 to send input data 20 to a remote server 16. Similarly, FIG. 6B shows a remote server 16 sending output data 22 to the student 24, CSO 26 and school 28 information appliances 14.

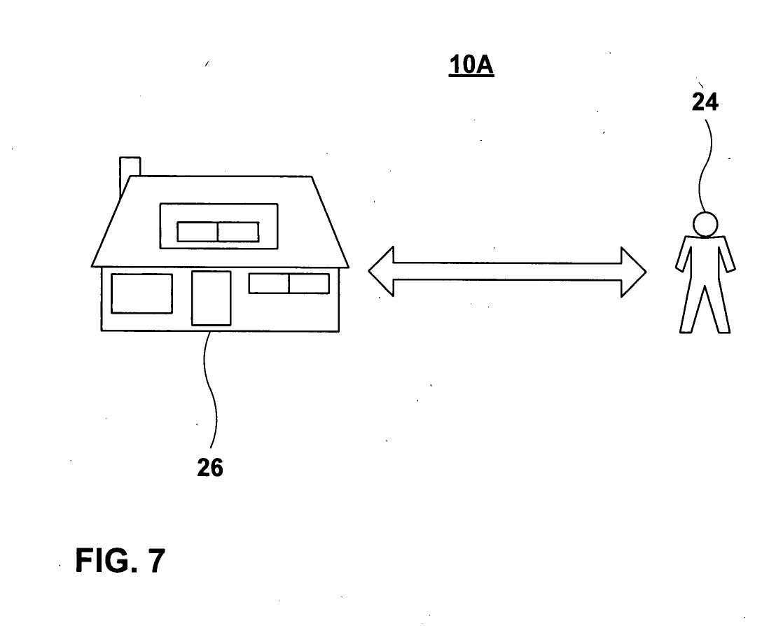

In the embodiment shown in FIG. 7, CSOs 26 that are looking for volunteers are matched with students 24 who must engage in community service activities to meet school or other student organization requirements. The means for matching may be in person, via the telephone or otherwise.

The difficulty today, however, is that students 24 are not aware of community service opportunities and CSOs 26 are not aware of students 24 seeking community service opportunities. Notwithstanding the existence of social media, information flows are today still largely “stove piped” and word-of-mouth. A CSO 26 may place an article or advertisement in a newspaper looking for student volunteers; most students 24 today use electronic media and do not read newspapers. A CSO 26 may have a Web site, but unless a student 24 has a particular interest in that CSO's 26 activities, a student 24 is not likely to visit the Web site.

A further issue is timeliness. Even with the best outreach techniques, CSOs 26 may not be able to attract student 24 volunteers unless the event 32 is scheduled well in advance.

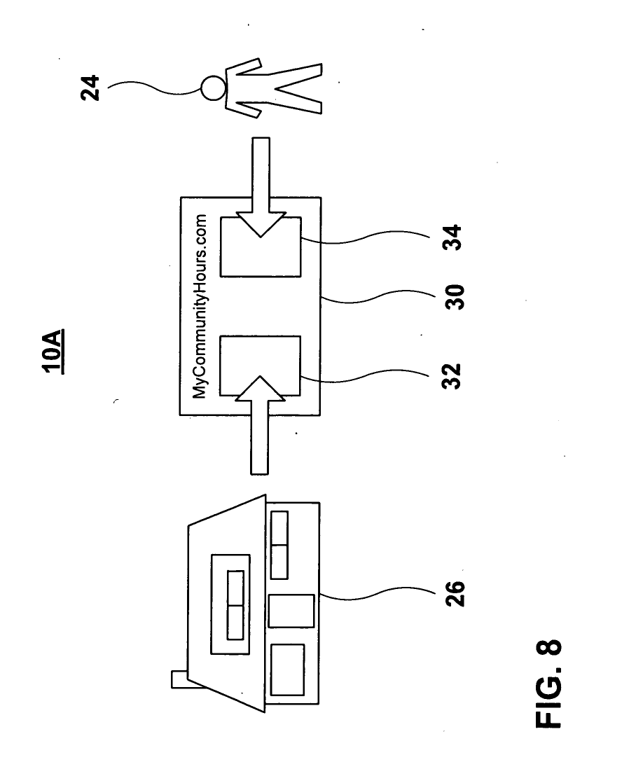

One embodiment of the matching means is a Web site 30, as shown in FIG. 8, that aggregates and updates community service opportunities in one place in real time that students 24 may easily access. CSOs 26 list events 32 for which they seek volunteers. Students 24 search available events 32 and register to participate in them 34.

In one embodiment, the Web site 30 runs on a remote server 16, which includes a remote server memory 16M. The Web site 30 is generated by a software program 16S that is stored and which operates on the remote server 16.

In this Specification, and in the Claims that follow, the term “user” may include a student 24, a CSO representative 26A, a school representative 28A, or any other person or device that accesses the Web site 16. The term “Web site” is intended to encompass any display or interface 14Z that is viewed or changed using an information appliance 14.

A user 12 may view and then log on to the Web site 30 using a variety of information appliances 14, including, but not limited to, a cell phone 14D, a Smart Phone 14E, a personal computer 14F, a laptop computer 14G, a Personal Digital Assistant (“PDA”) 14H, a tablet 14I, a gaming device 14J, or any other device that is suitable for using a Web site 30. The information appliance 14 includes an information appliance memory 14M.

The user 12 may connect to the remote server 16 by employing a wired or wireless network 18. In one embodiment, a user 12 views the Web site 30 employing a personal computer 14F that is connected to the Internet over a land line 18A. In another embodiment, a user 12 may view the Web site 30 on his or her Smart Phone 14E via a connection to a cellular telephone network 18C or Wi-Fi network 18D.

When the user 12 logs on to the Web site 30 and supplies information 20 that updates the Web site 30, the updated information 20 is stored in the memory 16M of the remote server 16. The memory 16M of the remote server 16 is transformed, and changes its state. When the user 12 operates his or her information appliance 14 by viewing or updating the Web site 30, the memory 14M of the information appliance 14 is transformed, and changes its state.

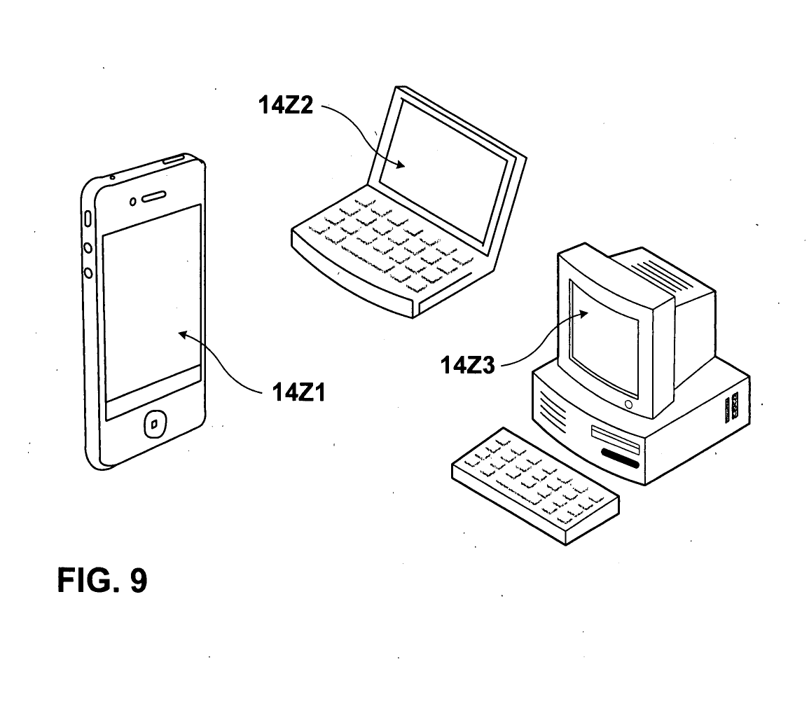

The results of the invention disclosed herein depend upon the transformation and changed state of the physical hardware, the information appliances 14 and the remote server 16, operated by users 12, students 24, CSOs 26 and schools 28. The transformations and changed states are evidenced by alterations in any display or interface 14Z of an information appliance. A student's display or interface 14Z1 may track accumulated community service hours, events 32 for which he or she is registered 34, and evidence of completion of events, or other information. The display 14Z2 of a CSO representative 26A may show the number of students 24 registered for an event 32 or may be used to display the particulars of an event 32, or other information. The display 14Z3 of the representative 28A of a school 28 may list the number of events 32 completed by a particular student 24 and whether the student 24 has completed the requirements for participation in the event 32, or other information. See FIG. 9.

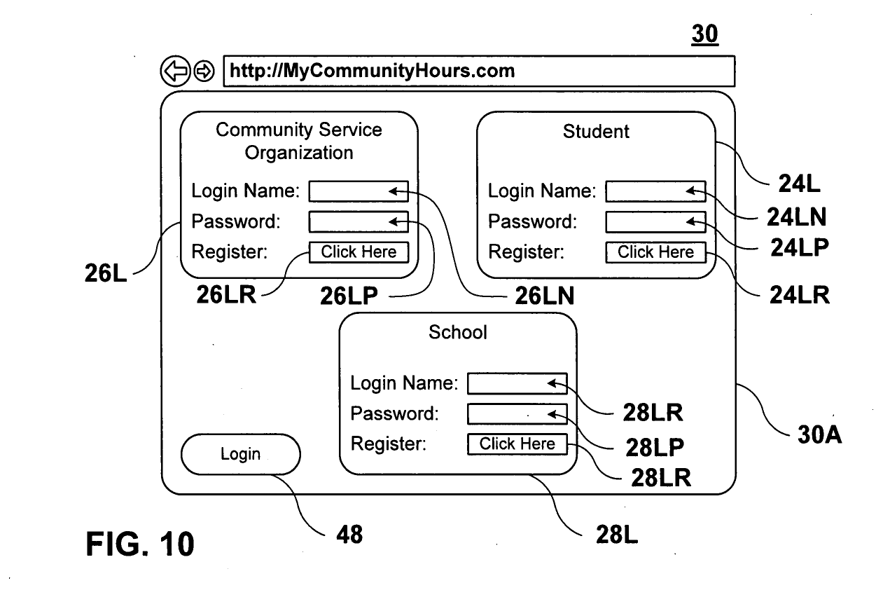

FIG. 10 shows a first Web site screen 30A through which CSO representatives 26A, students 24, and school representatives 28A may register or login to the Web site 30.

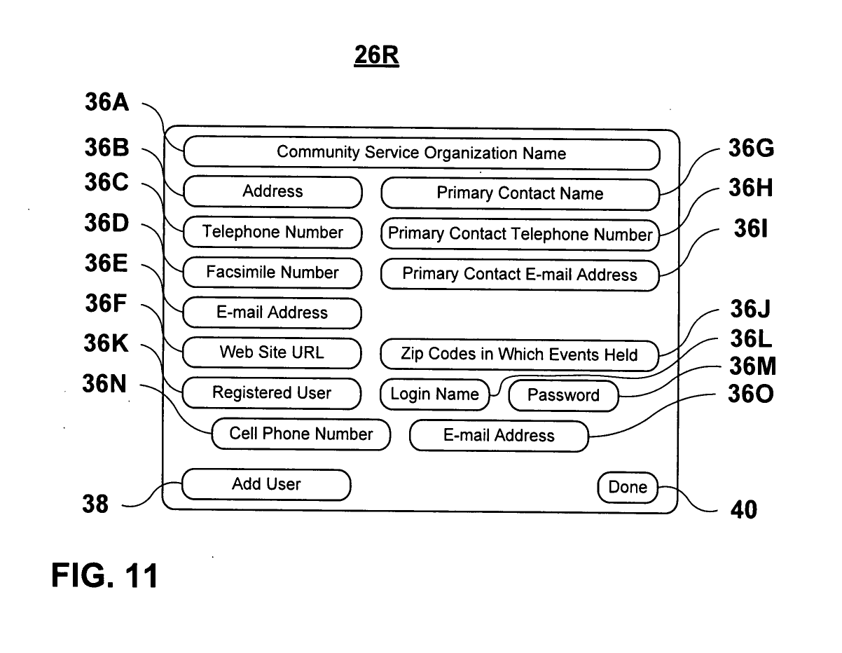

A representative of a community service organization 26A clicks the register button 26LR on a first Web site screen 30A to bring up a community service organization registration popup box 26R for entering CSO registration data 36 as shown in FIG. 11. The CSO representative enters the name of the CSO 36A, the CSO address 36B, telephone number 36C, facsimile number 36D, CSO electronic mail (“e-mail”) address 36E, and Web site Uniform Resource Locator (“URL”) 36F. The name of the CSO primary contact 36G, his or her contact telephone number 36H, and e-mail address 361 are entered. The CSO representative also enters a list of Zip Codes in which the CSO holds events 36J. A registered user's name 36K, login name 36L, password 36M, cell phone number 36N, and e-mail address 36O are entered. A CSO may authorize multiple users of the Web site 30. Clicking the add user button 38 allows additional users to be registered. Clicking the done button 40 brings up the first Web site screen 30A as shown in FIG. 10.

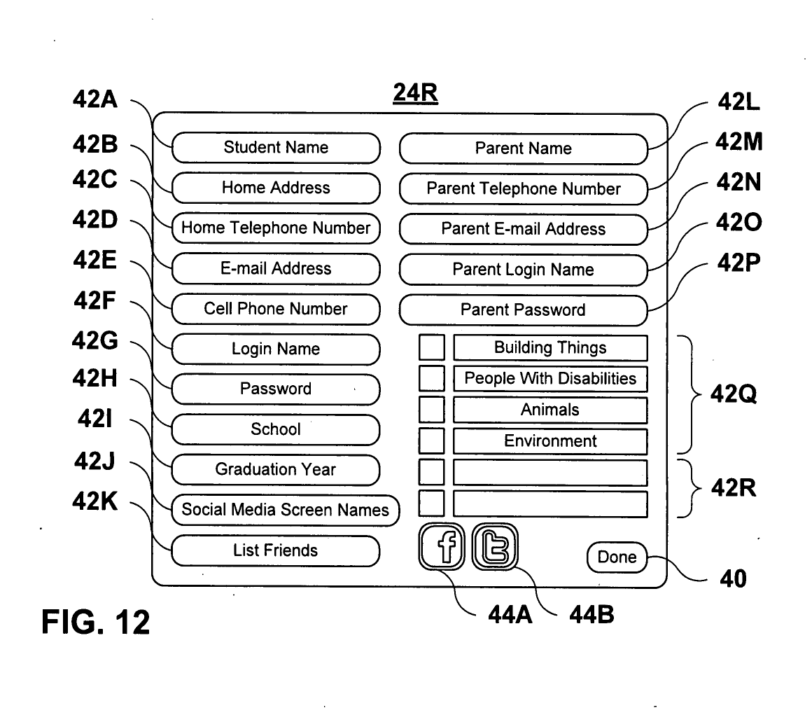

A student 24 clicks button 24LR on a first Web site screen 30A to bring up a student registration popup box 24R for entering student registration data 42 as shown in FIG. 12. The student 24 enters his or her name 42A, home address 42B, home telephone number 42C, e-mail address 42D, cell phone number 42E, login name 42F, password 42G, the name of his or her school 42H, year of graduation 421, and any social media screen names 42J. The student 24 may list friends 42K with whom they would like to join or have join an event. The student 24 also enters his or her parent or guardian's name 42L, their telephone number 42M, e-mail address 42N, login name 42O, and password 42P. The student 24 may also check boxes 42P to indicate their interest in particular types of community service activities or events. The student 24 may also define his or her own interests 42R by filling in the boxes. Screen 24R also displays links to social media sites 44 such as Facebook® 44A and Twitter® 44B. Clicking the done button 40 brings up the first Web site screen 30A as shown in FIG. 10.

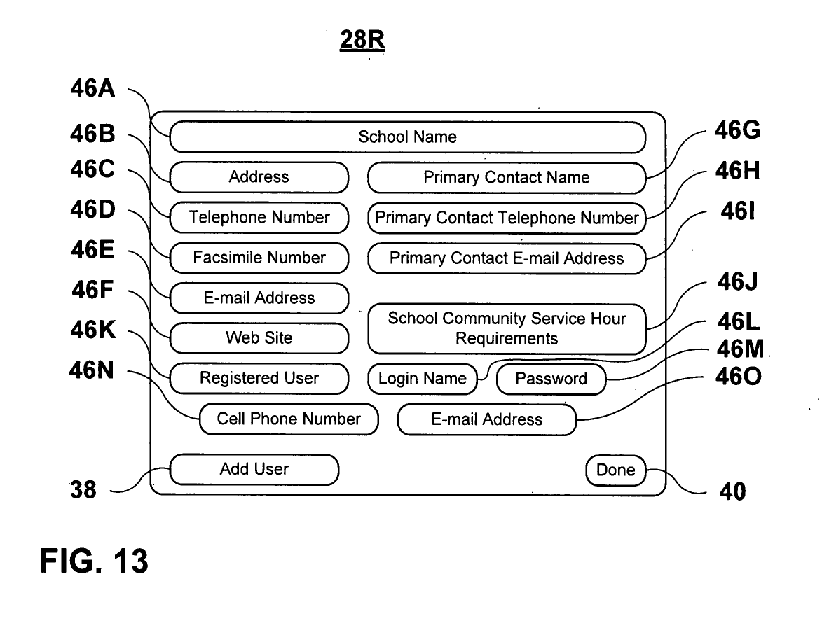

A school representative 28L clicks the register button 28LR on a first Web site screen 30A to bring up a school registration popup box 28R for entering school registration data 46 as shown in FIG. 13. The school representative enters the name of the school 46A, the school address 46B, telephone number 46C, facsimile number 46D, school e-mail address 46E, and Web site Uniform Resource Locator (URL) 46F. The name of the school primary contact 46G, his or her contact telephone number 46H, and e-mail address 461 are entered. The school representative also enters the number of community service hours required of each student 24 according to his or her grade 46J. These community service hours may be per academic year, or cumulative, or some other accounting. A registered user's name 46K, login name 46L, password 46M, cell phone number 46N, and e-mail address 46O are entered. A school may authorize multiple users of the Web site 30. Clicking the add user button 38 allows additional users to be registered. Clicking the done button 40 brings up the first Web site screen 30A as shown in FIG. 10.

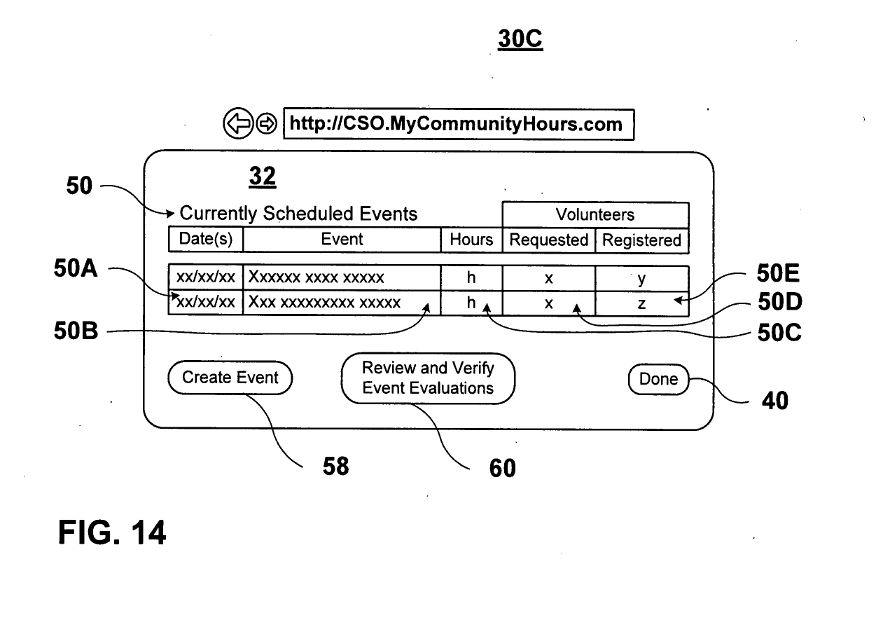

When a representative of a community service organization 26A enters his or her login name 26LN, 36L and password 26LP, 36M on the first Web site screen 30A as shown in FIG. 10 and clicks the login button 48, the CSO's home page 30C appears as shown in FIG. 14.

The community service organization home page 30C shows the status 50 of currently scheduled events, including the date or dates 50A, a description of the event 50B, the number of community service hours available for participating 50C, the number of volunteers the CSO is seeking 50D, and the number of volunteers registered for the event 50E.

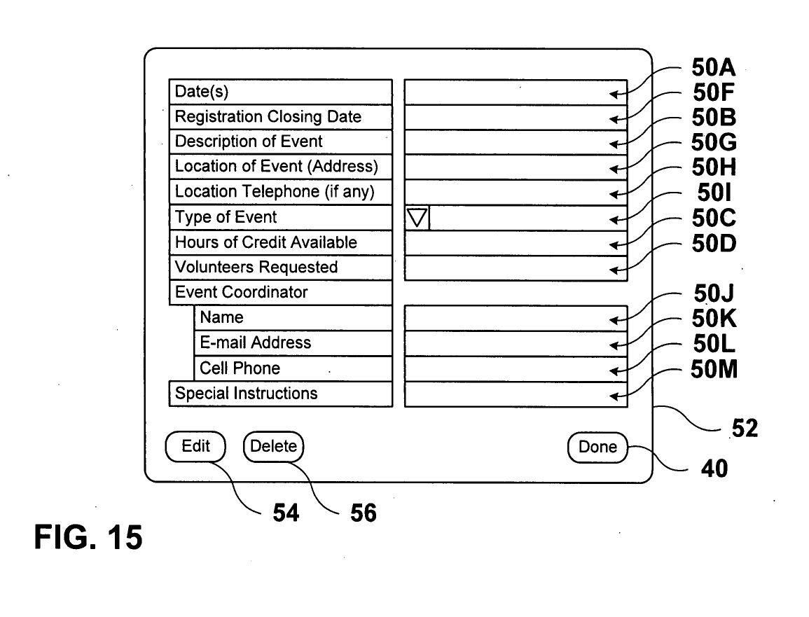

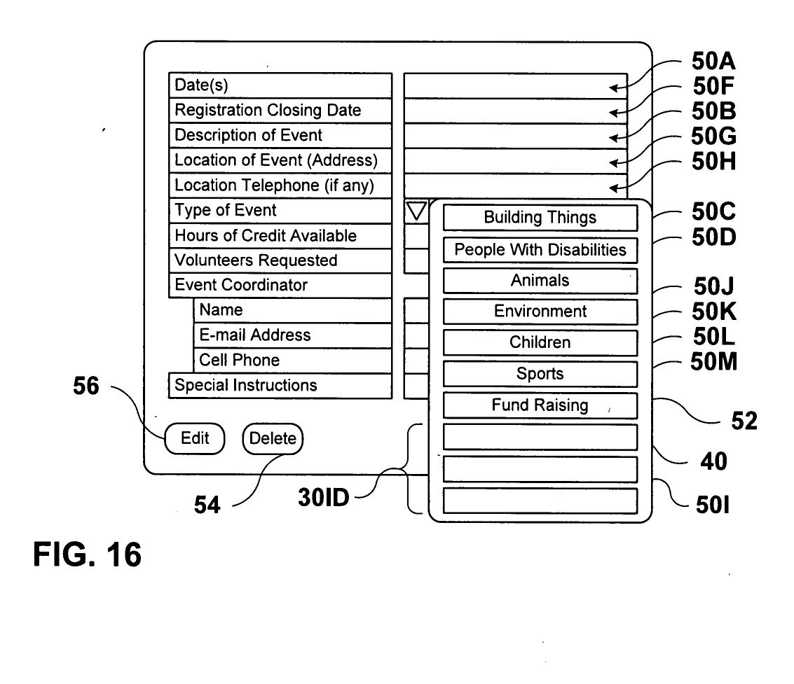

Clicking on an event 32 brings up popup box 52 as shown in FIG. 15. Information for that event 32 is displayed, which can be edited by clicking the edit button 54. Popup box 52 containing more status information 50 than is displayed on the community service organization home page 30C, including the event registration closing date 50F, the location of the event 50G, including its address, and the telephone number at the event location 50H, if any. The type of event is selected from pull down menu 50I. Unique type descriptions may be directly entered in box 50I as shown in FIG. 16. The name 50J, e-mail address 50K, and cell phone number 50L of the event coordinator is also available in FIG. 15. Any special instructions 50M are also displayed.

The event 32 may be cancelled, and the event deleted, by clicking delete button 56. Clicking done 40 closes popup box 52, bring up the community service organization home page 30C shown in FIG. 14.

Clicking the create event button 58 on the community service organization home page 30C shown in FIG. 14 brings up a blank version of popup box 52, which may be used to schedule an event 32.

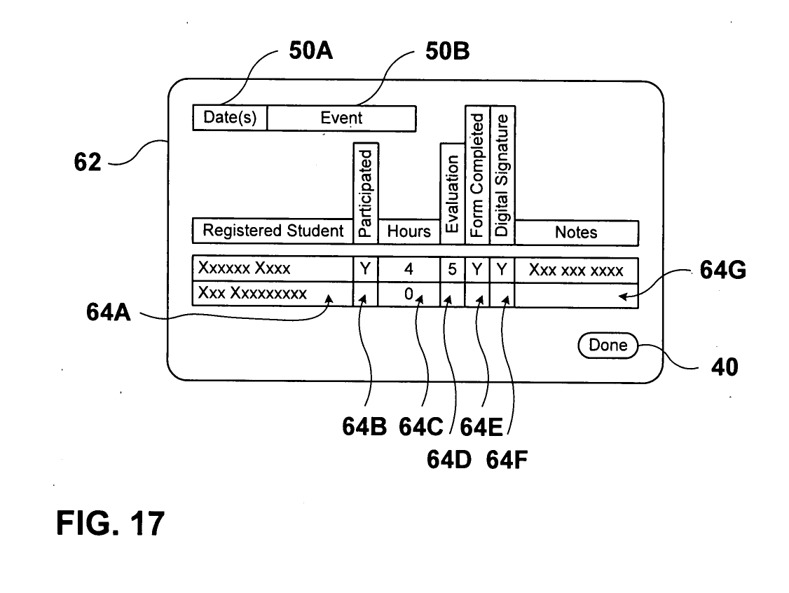

To get credit for community service hours, most schools 28 require students 24 to complete an evaluation form and have it signed by the CSO event coordinator 50J or other representative of the CSO. Clicking button 60 on the community service organization home page 30C shown in FIG. 14 brings up popup box 62, shown in FIG. 17, which shows the status of student participation in an event 64, including evaluation forms. Popup box 62 shows students 24 that registered for the event 64A, students that participated in the event 64B, community service hours for participation 64C, the community service event coordinator evaluation of student participation in event 64D, whether the student has completed his or her evaluation form 64E, a community service organization representative digital signature 64F, and any notes concerning student participation in event 64G.

One embodiment of the Community Service Reconciliation System 10A fills in the names of the students 24 that registered for the event 64A in popup box 62. The CSO event coordinator 50J or other representative of the CSO enters a “Y” in box 64B to show that the particular student 24 participated in the event, fills in the number of hours of community service credit given 64C to that student for the event, and evaluates the student's 24 participation 64D on a scale, for example, from 1 to 5 or from 1 to 10. A box 64E is marked to show that the student 24 has completed his or her evaluation form for the event 32.

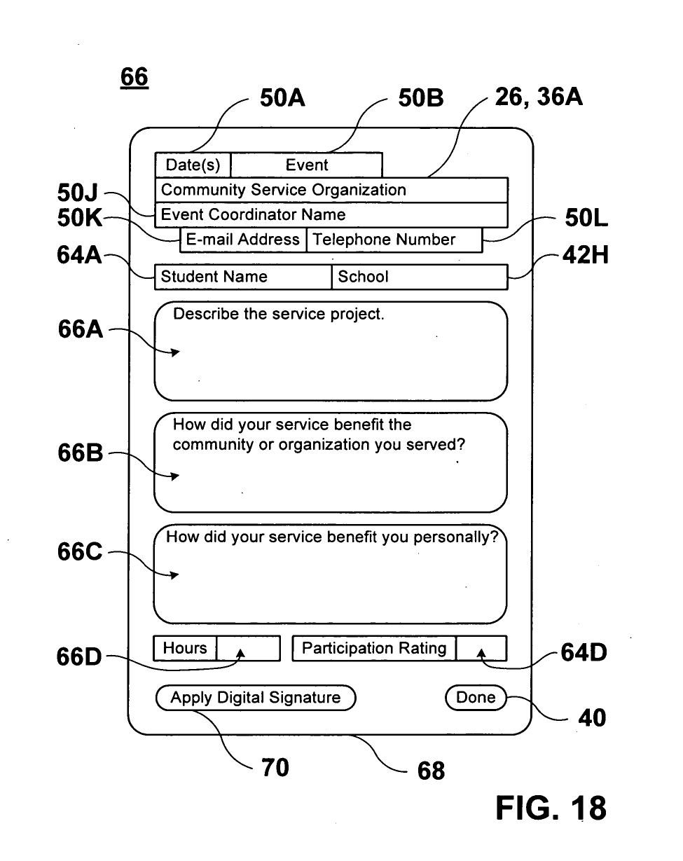

If box 64E shows that the student 24 has completed his or her evaluation form for the event 66, the CSO event coordinator 50J or other representative of the CSO may click box 64E to see the evaluation form 66 in popup box 68 as shown in FIG. 18. The event date(s) 50A, the description of the event 50B, the name of the sponsoring community service organization 26, 36A the CSO event coordinator name 50J, e-mail address 50K, telephone number 50L, registered student name 52A, and his or her school 42H are then provided. The student 24 that participated in the event completes the evaluation form 66 by answering the questions 66A, “Describe the service project,” 66B, “How did your service benefit the community or organization you served,” 66C, “How did your service benefit you personally,” and 66D, the number of hours of community service claimed. The CSO event coordinator 50J or other representative of the CSO may change the number of community service hours claimed 66D to match the number granted by the CSO 64C.

The CSO event coordinator 50J or other representative of the CSO may enter his or her rating of the student's participation in the event 64D. As an alternative, the value 64D will automatically be transferred from popup box 62.

The CSO event coordinator 50J or other representative of the CSO may “sign” the evaluation form 66 by clicking the apply digital signature button 70. Doing so causes a “Y” to appear in box 64F on the community service organization popup box 62, shown in FIG. 16, which shows the status of student participation in an event. Clicking the done button 40 brings up the community service organization popup box 62 shown in FIG. 16.

The CSO event coordinator 50J or other representative of the CSO may add notes about any student participant 52B by entering them in box 64G.

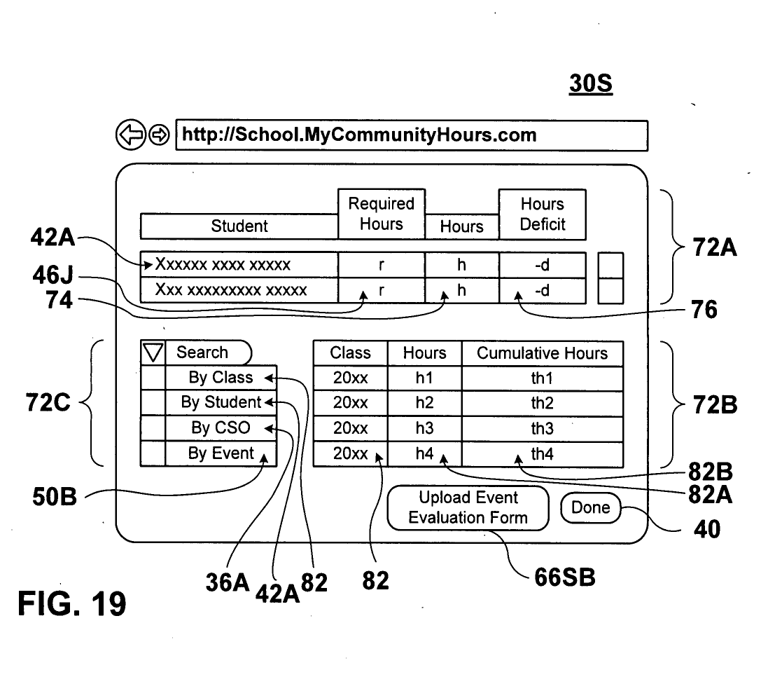

Schools may upload their own event evaluation forms 66S and define the questions 66A to 66D to be answered by the student 24 by clicking button 66SB on the school Web site home page 30S shown in FIG. 19.

Clicking the done button 40 closes popup box 62, bring up the community service organization home page 30C shown in FIG. 14.

When a school representative 28A enters his or her login name 28LN and password 28LP on the first Web site screen 30A as shown in FIG. 10 and clicks the login button 48, the school's home page 30S appears as shown in FIG. 19. The school home page 30S comprises three sections 72: one displaying warnings or alerts 72A that students 24 are not meeting their hours requirements; one displaying various statistics 72B; and a search bar 72C.

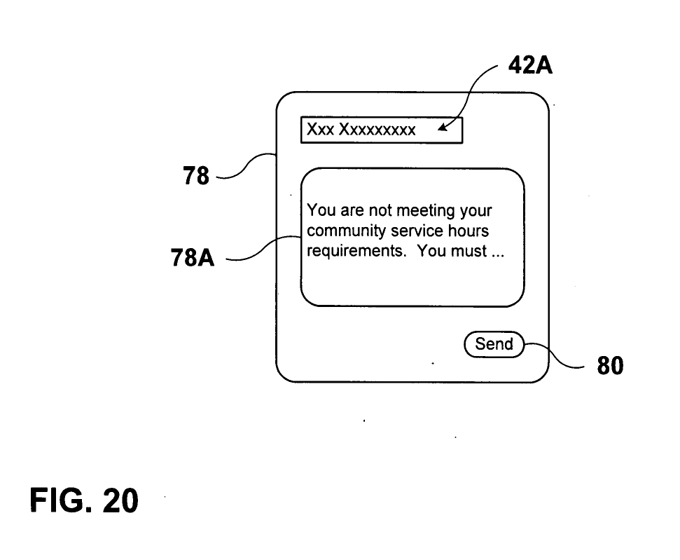

The warnings and alerts section 72A of the school home page 30S in FIG. 19 shows the names of students 42A who are not meeting their required community service hours 46J. The number of hours a student 24 has accumulated 74 is compared to the required hours 46J and the deficit displayed 76. Clicking a student's name 42A on the school home page 30S brings up popup box 78 that allows a school representative 28A to send to the student 24 an e-mail, text or other communication 78A reminding the student 24 of his or her community service hours deficit 76. See FIG. 20. Clicking the send button 80 sends the message and closes the popup box 78.

The statistics 72B section of the school home page 30S displays statistics about the students' 24 community service hours. In the embodiment shown in FIG. 19, the hours of community service 82A and the class total cumulative community service hours 82B are displayed by class year 82.

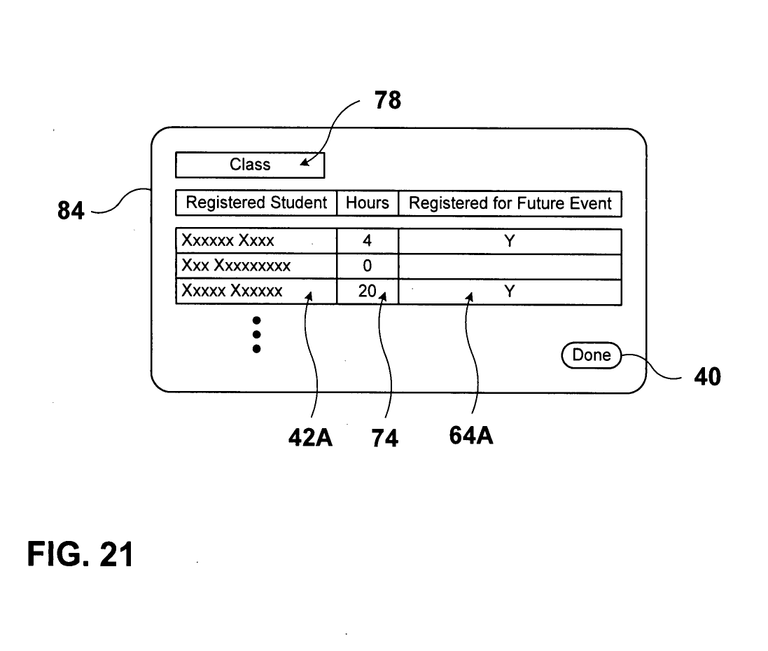

Finally, a school representative 28A may search 72C by class 82, by student 42A, by community service organization 36A, or by event 50B. In an embodiment shown in FIG. 21 for example, searching 72C by class 82 brings up popup box 84 that shows a list of students 24 in that class who are enrolled, the number of community service hours they have accumulated to date 74, and whether he or she is registered for a future event 64A. Clicking done 40 closes the popup box 84.

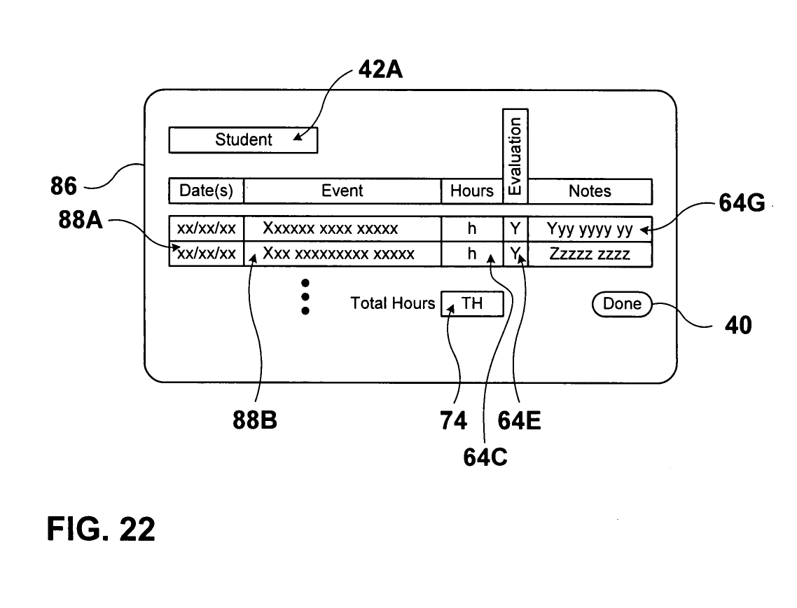

In an embodiment shown in FIG. 22, for example, searching 72C by student 42A brings up popup box 86 that shows community service events 88B in which the student participated, the dates of the community service event 88A, the number of hours accumulated for the event 64C, whether the student 42A has completed the evaluation form 64E, and any notes 64G. The total hours 74 accumulated by the student 42A are also shown. A school representative 28A clicking the evaluation box 64E brings up the student evaluation 66 of the event shown in FIG. 18, which evaluation 66 may be downloaded and/or printed. Clicking done 40 closes the popup box 86.

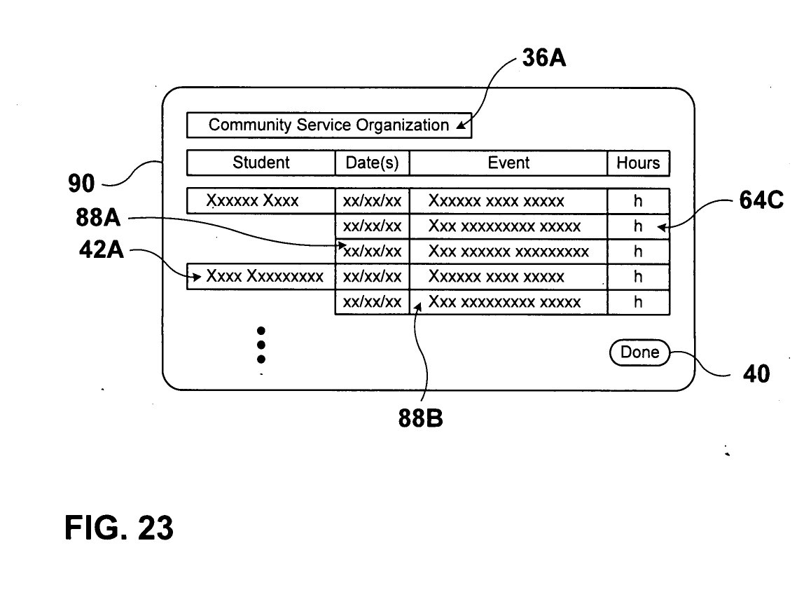

In an embodiment shown in FIG. 23, for example, a school representative 28A searching 72C by community service organization 36A brings up popup box 90 that shows the names of students 42A at that school 46A that have or are participating in events sponsored by that CSO 36A. Clicking done 40 closes the popup box 90.

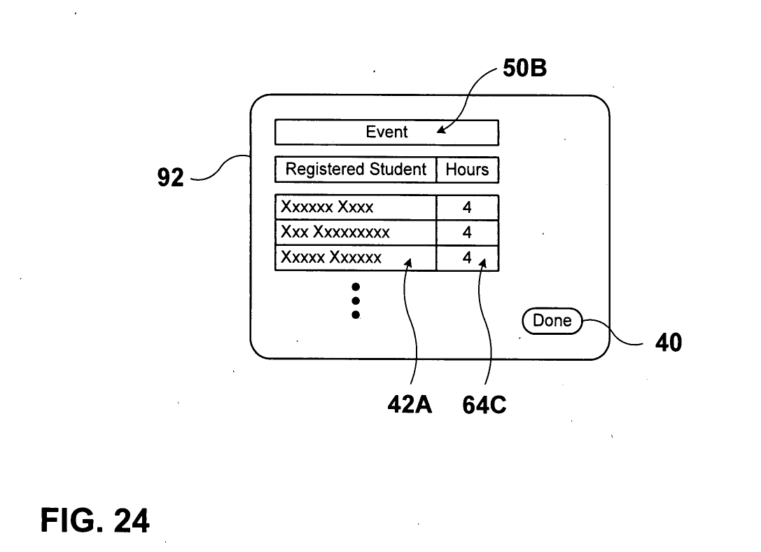

In an embodiment shown in FIG. 24, for example, a school representative 28A searching 72C by CSO event 32 brings up popup box 92 that shows the names of students 42A at that school 46A that have or are participating in the specific event 32. Clicking done 40 closes the popup box 92.

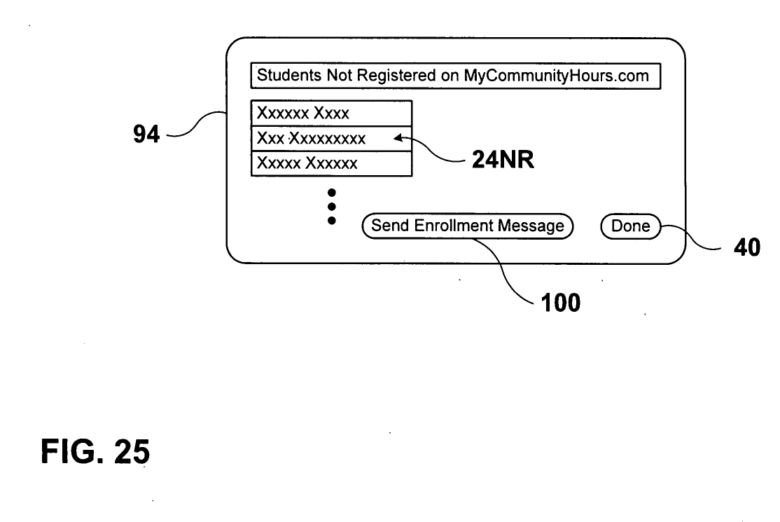

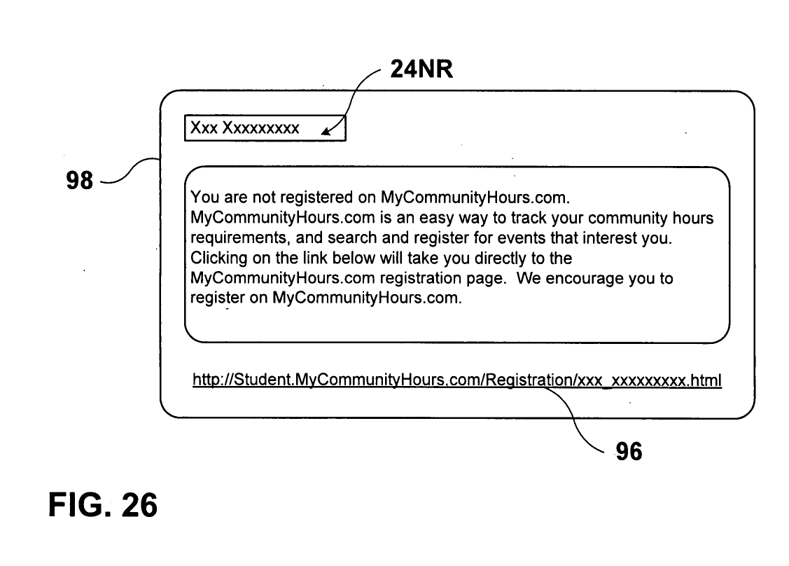

A school representative 28A may compare the school's registered student list with the names of students 42A who are already registered on the Web site 30. The results of this matching are shown in popup box 94 as shown in FIG. 25. The school representative 28A may select one or more or all of the names 24NR shown in popup box 94 to send a link 96 in a message 98 via e-mail, social media or other contact method by clicking button 100 asking the student 24NR to register on the Web site 30. The message 98 to the student(s) 24 is shown in FIG. 26. When the student 24NR clicks the link in the message 98, the student registration Web page 24R, shown in FIG. 12, pops up partially completed by the disclosed invention. The student 24NR may complete the registration process as described above.

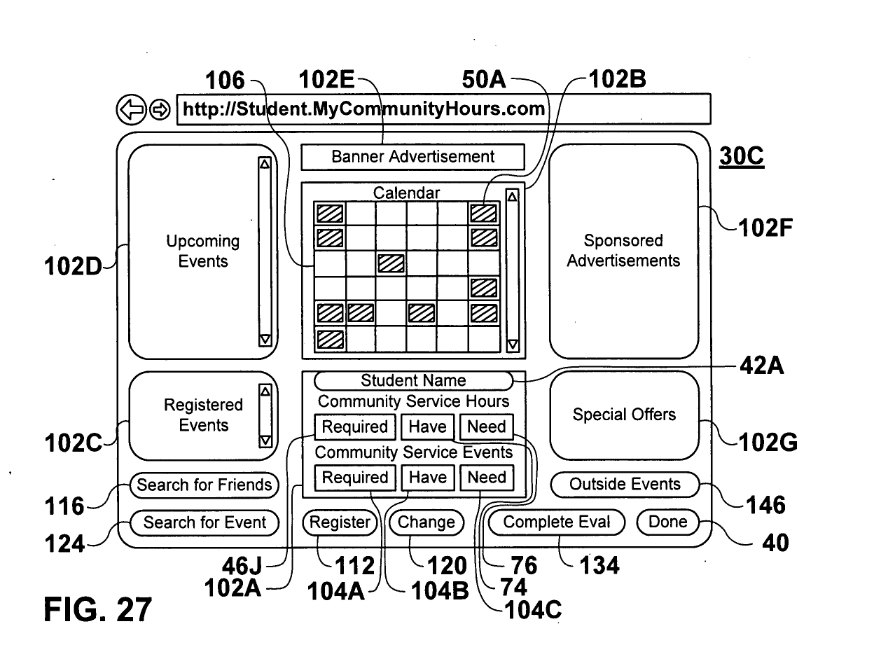

When a student 24 enters his or her login name 24LN and password 24LP on the first Web site screen 30A as shown in FIG. 10 and clicks the login button 48, the student's home page 30U appears as shown in FIG. 27. The student's home page 30U comprises a plurality of sections 102.

The student's name 42A and the current status of his or her community service hours are displayed in the current status section 102A of the student's home page 30U. Included here are the number of community service hours required 46J, the number of community service hours completed 74, and the number of remaining required community service hours 76.

In addition to requiring hours of community service, some schools and organizations require participation in a number of events. The current status section 102A of the student's home page 30U also displays the required number of community service events 104A, the number of events in which the student 42A has participated 104B, and the number of remaining required events 104C.

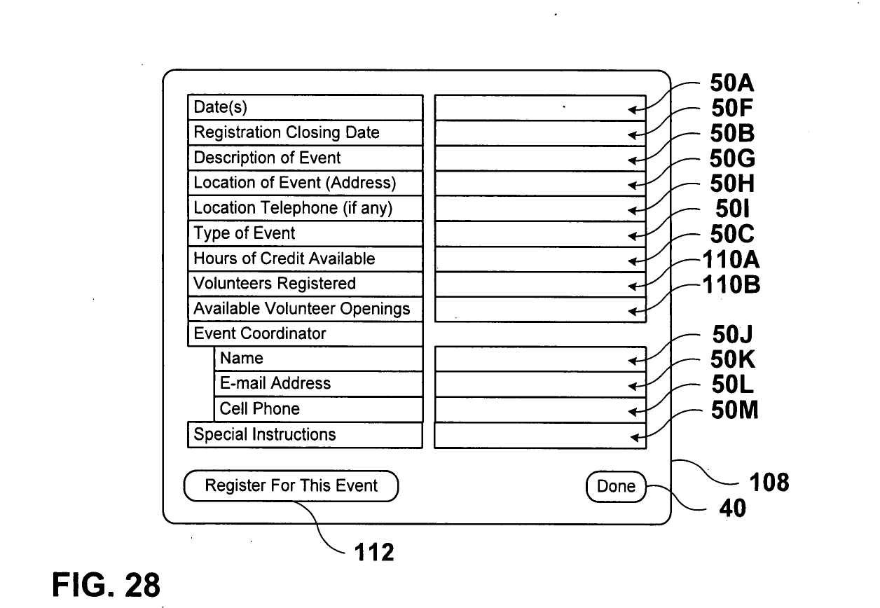

The calendar section 102B of the student's home page 30U displays CSO events 32 in a calendar 106 format. Clicking on an event 50A in the calendar 106 brings up an event description popup box 108 as shown in FIG. 28. Popup box 108 is basically identical to popup box 52 shown in FIG. 15 with the addition of the number of students 42A already registered for the event 110A, the number of remaining available volunteer positions 110B, and button 112 to allow the student 42A to register for the event. Clicking done 40 closes the popup box 108.

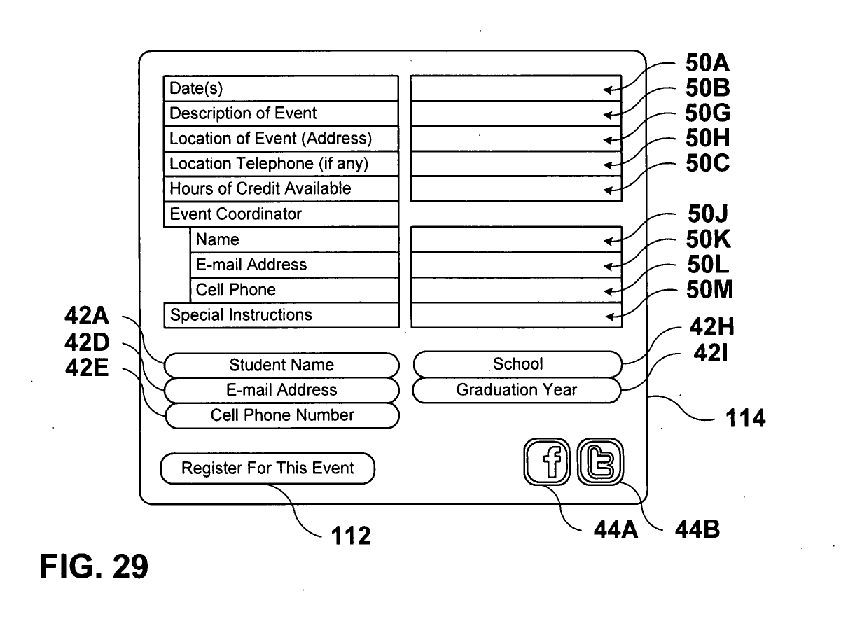

If the student clicks the registration button 112 in popup box 108, registration popup box 114 is displayed as shown in FIG. 29. The CSO event information 50 and the student information 42 are automatically entered into popup box 114 as a result of the student having clicked the registration button 112 on popup box 108. Popup box 114 displays the date(s) 50A of the community service event 18, a description of the event 50B, the location of the event 50G, the location telephone number (if any) 50H, the number of available community service hours 50C, the event coordinator name 50J, e-mail address 50K, cell phone number 50L, and any special instructions 50M. Popup box 114 further displays the student's name 42A, e-mail address 42D, cell phone number 42E, school 42H and graduation year 421. Clicking the register button 100 again will register the student 42A for the selected community service event 32 and close popup box 114. An e-mail or social media message will be generated to the student 42A confirming his or her registration.

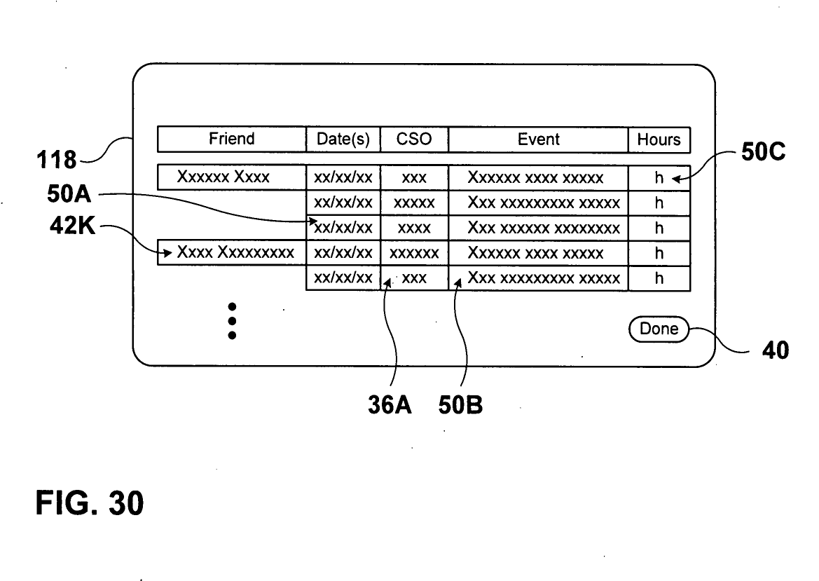

In a preferred embodiment, a student 42A may search for CSO events 32 for which his or her friends 42K have already registered by clicking button 116 on his or her home page 30U. See FIG. 27. The results of that search are displayed in popup box 118 as shown in FIG. 30. Clicking any event 32 shown in FIG. 30 brings up popup box 114 allowing the student 42A to register for an event 32 for which a friend 42K has already registered.

In a preferred embodiment, if the student 42A clicks either the Facebook button 44A and/or the Twitter button 44B before clicking the register button 112, upon clicking the register button 112 a Facebook and/or Twitter message will be generated telling the student's friends that he or she has registered for this community service event 32 and inviting them to likewise register. Facebook and Twitter are but two of the various social media sites that may be represented.

Upon registration, the community service event 32 will appear in the registered events section 102C of the student's home page 30U. See FIG. 27. The registered events section 102C displays all of the CSO events 32 for which the student 42A is registered. In one embodiment the CSO events 32 listed in section 102C are eliminated after the date of the event 50A passes. In an alternative embodiment the community service event 32 is eliminated only after the student 24 completes his or her evaluation form 66.

A variety of upcoming CSO events 32 may be displayed in the upcoming events section 102D of the student's home page 30U. Clicking on an event 32 in the upcoming events section 102D brings up the event description popup box 108 as shown in FIG. 28. The student 42A may follow the same procedure as described above to register for the selected event 32.

Rather than clicking on a community service event 32 in either the calendar 106 or in the upcoming events section 102D, a student 24 may highlight the selected community service event 32 and click the register button 112 shown on his or her home page 30U. See FIG. 27. Doing so brings up the event description popup box 108 as shown in FIG. 28, and the student 24 may follow the same procedure as described above to register for the selected event 32.

A student 24 that needs to change or modify his or her participation in a community service event 18 may highlight the event 50B in the registered events section 102C and click the change button 120. Clicking the change button 120 brings up popup box 122, through which the student 42A may cancel his or her registration for the selected community service event 32. Clicking the change button 120 on popup, box 122 unregisters the student 42A for the selected community service event 32 and closes popup box 122. An e-mail will be generated to the student 42A confirming his or her unregistration. Additionally, the volunteers registered 110A will be reduced and the available volunteer openings 110B increased in popup box 108. See FIG. 28.

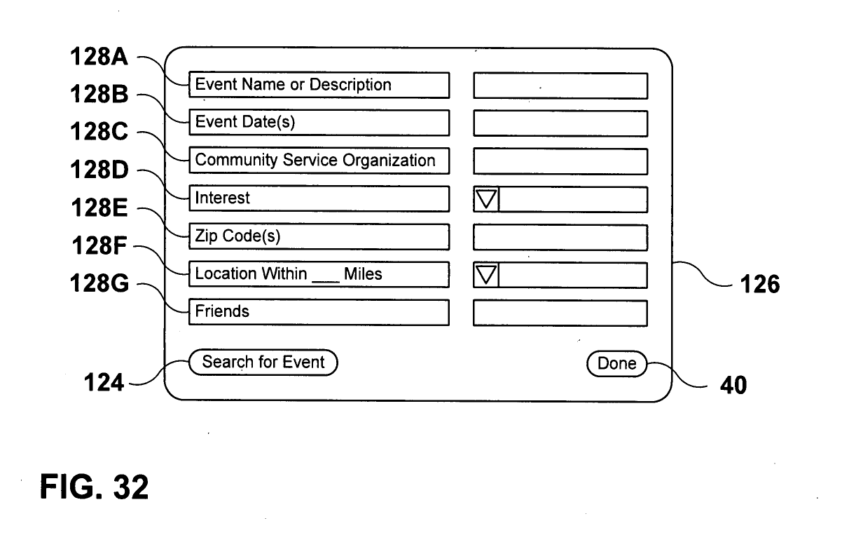

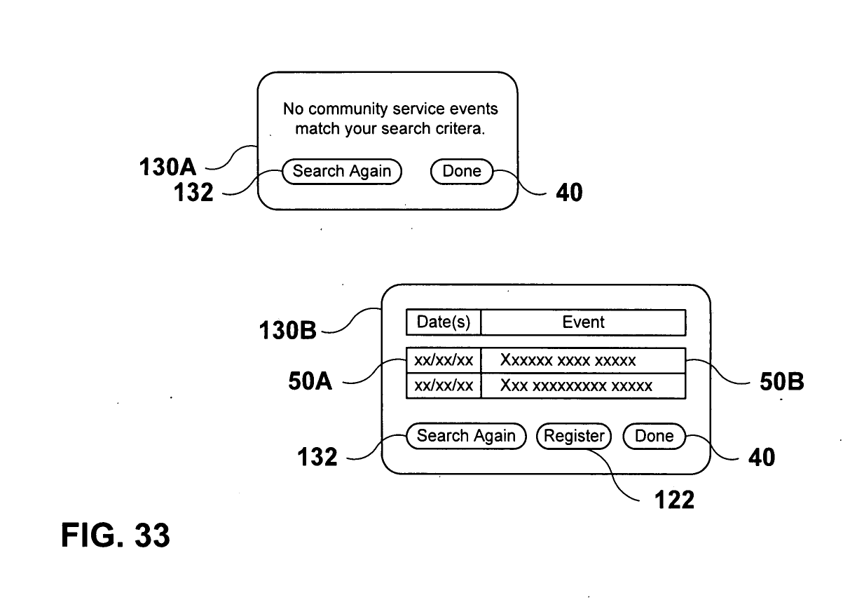

A student 24 may search for a particular community service event by clicking search bar 124 that brings up popup box 126 as shown in FIG. 32. A student 24 may enter one or more search query items 128 such as the name or description of the event 128A or date 128B or community service organization 128C or interest 128D (via pull down menu) or Zip Code 128E or locations within some number of miles of the student's home address (via pull down distance menu) 128F or events for which friends 30K have already registered 128G. Clicking search bar 124 again as shown in FIG. 32 yields the search results shown in FIG. 33.

Popup box 130A says that no community service event 32 matches the student's 42A search criteria 128. The student may search again by clicking button 132, which again brings up popup box 126 shown in FIG. 32. The student may also click done 40 to close popup box 130A.

Popup box 130B shows two CSO events 32 that meet the student's 42A search criteria 128. Clicking on a community service event 32 in popup box 130B, or a student 24 highlighting the selected community service event 32 and clicking the register button 112, brings up the event description popup box 108 as shown in FIG. 28, and the student 24 may follow the same procedure as described above to register for the selected event 32.

The student may search again by clicking button 132, which again brings up popup box 126 shown in FIG. 32. The student may also click done 40 to close popup box 130B.

Once the student 24 participates in a community service event 18, the complete evaluation button 134 on the student's home page 30U becomes illuminated. Clicking the evaluation button 134 brings up the community service event evaluation popup box 68 as shown in FIG. 18. The community service event information 50 and the student information 42 are automatically entered into popup box 68 as a result of the student having earlier registered for the event. The student 24 completes the event evaluation form 66A-66D and clicks the done button 40 to submit it to the community service organization 26 for verification. Upon completion of all outstanding community service event evaluations, the complete evaluation button 134 is no longer illuminated.

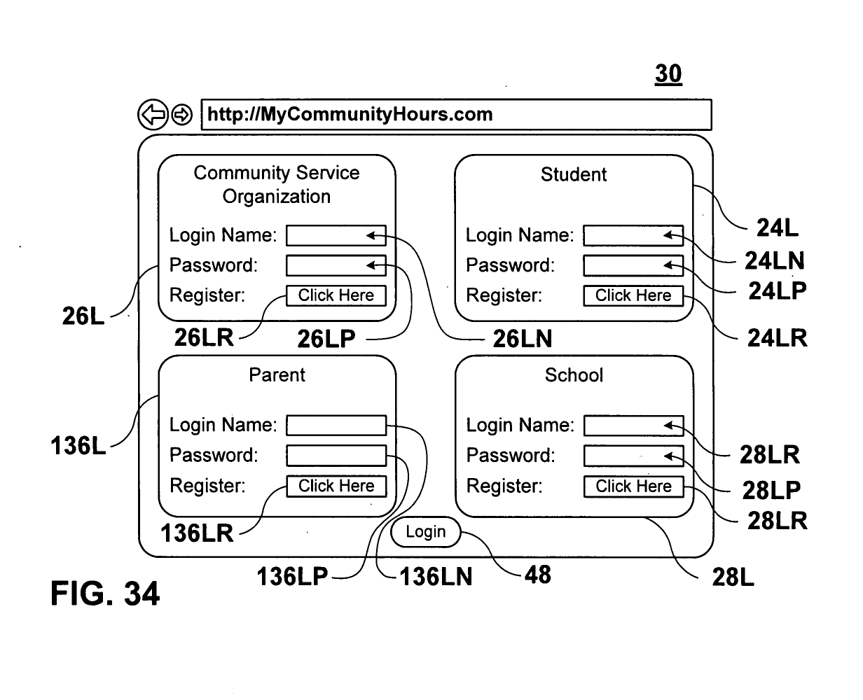

A student's parents 136 may wish to access the Web site to monitor their child's progress in meeting his or her community hours requirements or for other purposes such as registering the student 24 for CSO events 32. A parent clicks the register button 136LR on a first Web site screen 30A as shown in FIG. 34 to bring up the student's registration popup box 24R as shown in FIG. 12. The parent 136 may enter his or her login name 42N and password 42O in popup box 24R if the student has not already entered this information.

In a preferred embodiment of the invention, the CSO events 32 displayed in the upcoming events section 102D of the student's home page 30U are listed based upon a measure of desirability to the student 24. The measure of desirability may reflect a plurality of factors. For example, the CSO events 32 displayed in section 102D may reflect a student's 24 activity preferences 42P listed in order of distance from a student's home address 42B to the location of the event 50G. An additional measure of desirability might reflect the types of events the student 24 has participated in previously.

In a further embodiment, the Web site may suggest CSO events 32 that may be of interest to the student 24 based not only upon the plurality of factors described above, but also based upon looking at student 24 social media 44 entries and other sources of information outside the Web site. For example, the student's school 36 might suggest CSO events 32 of interest to the school administration. Such suggestions may be highlighted entries in section 102D of the student's homepage 30U, for example, flashing text.

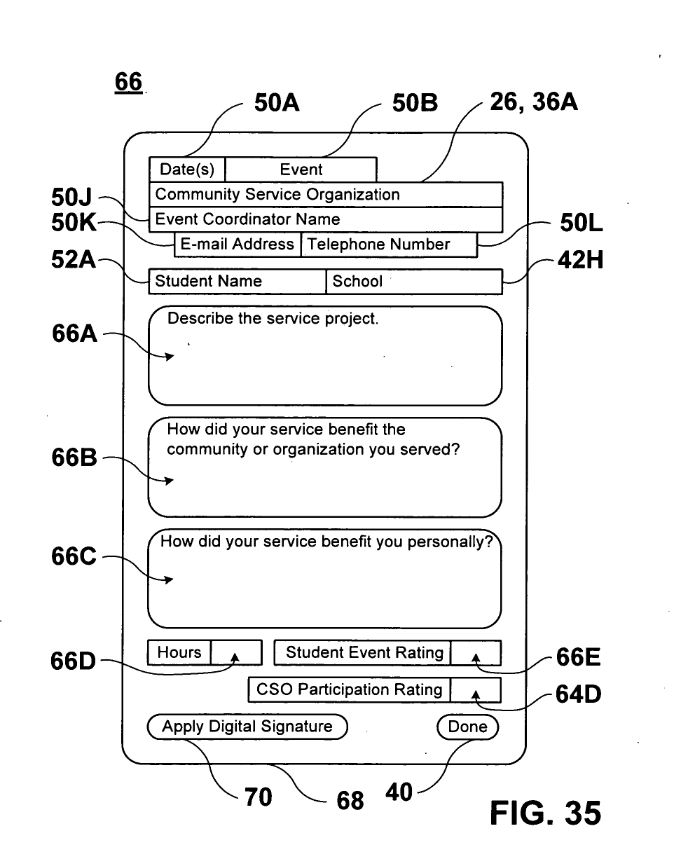

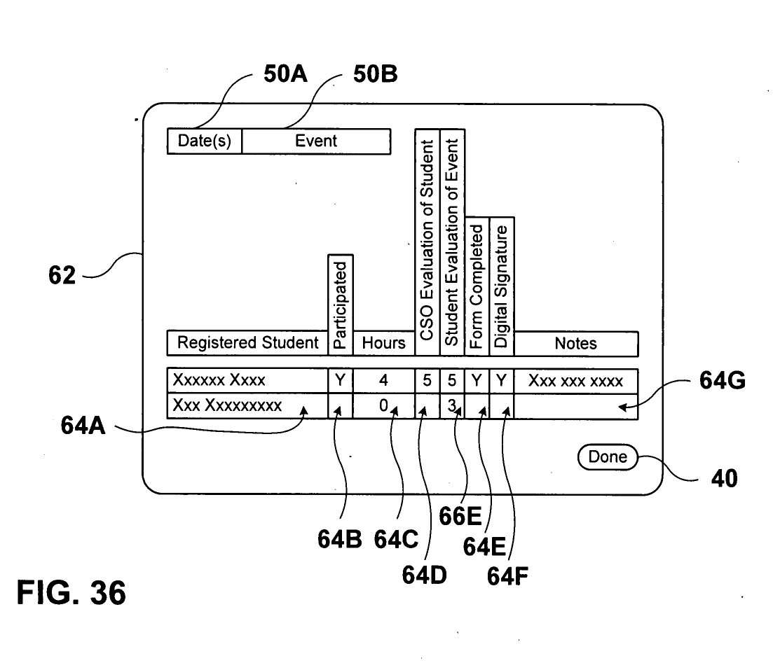

In the same vein as the CSO event coordinator 50J may rate a student's participation 64D in an event 32, in a preferred embodiment of invention, the student may rate the particular event 32 by entering a rating 66E on the event evaluation form 66. See FIG. 35, which is FIG. 18 with a box added for the student's rating 66E. The student's evaluation 66E may be reflected in the CSO event evaluation form popup box showing the status of student participation in an event 64, as shown in FIG. 36. FIG. 36 is FIG. 17 with a column added for the student rating(s) 66E of the event 32.

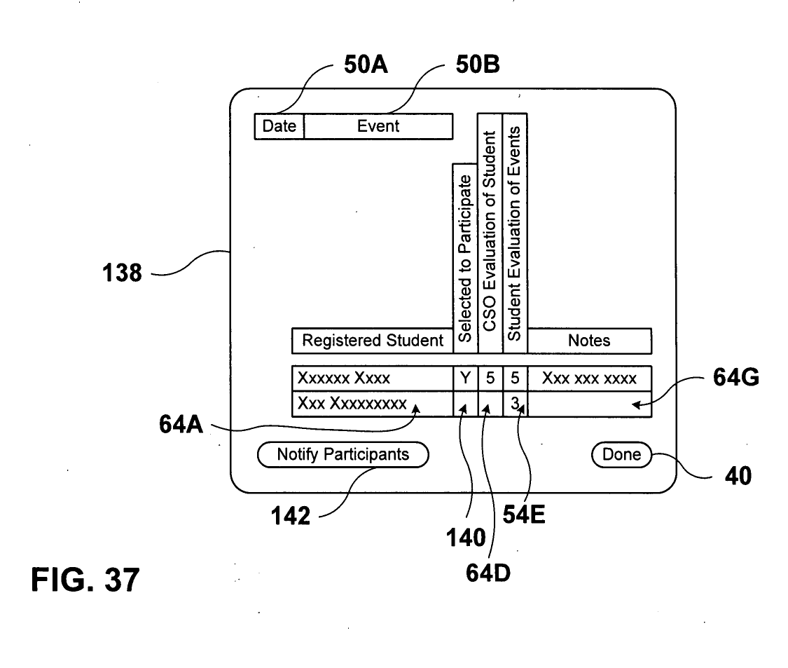

In an embodiment of Web site, both CSO ratings of student participation 64D in events and student ratings of CSO events 66E are available. These ratings may be used to determine which students 24 are permitted to register for and participate in events 32, particularly CSO events that are considered highly desirable for any number of reasons or simply over subscribed with registrations. For example, the “best students” 24 based upon the CSO ratings 64D have priority for the “best events” based upon the student ratings 66E. Implementing such a “priority” system requires the CSO 26 to have a registration reservation system such as is shown in FIG. 37.

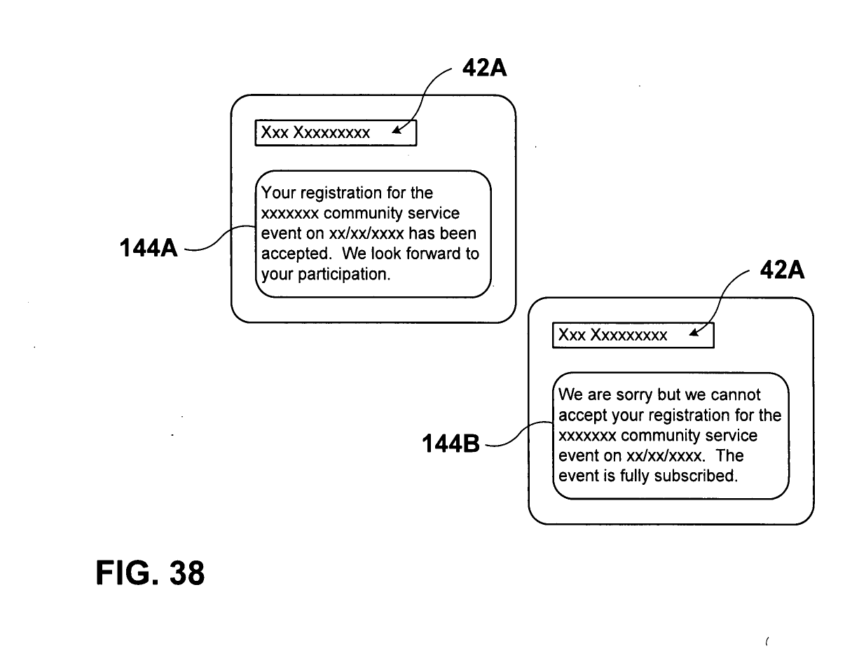

Popup box 138 lists the names of students 24 that have registered for a particular event 32. Students 24 that are selected to participate in the event 32 are indicated 140. Clicking button 142 sends a message to the registered students 64A telling them that their registration to participate in the event has been accepted 144A or that their registration has not been accepted 144B. The messages are shown in FIG. 38.

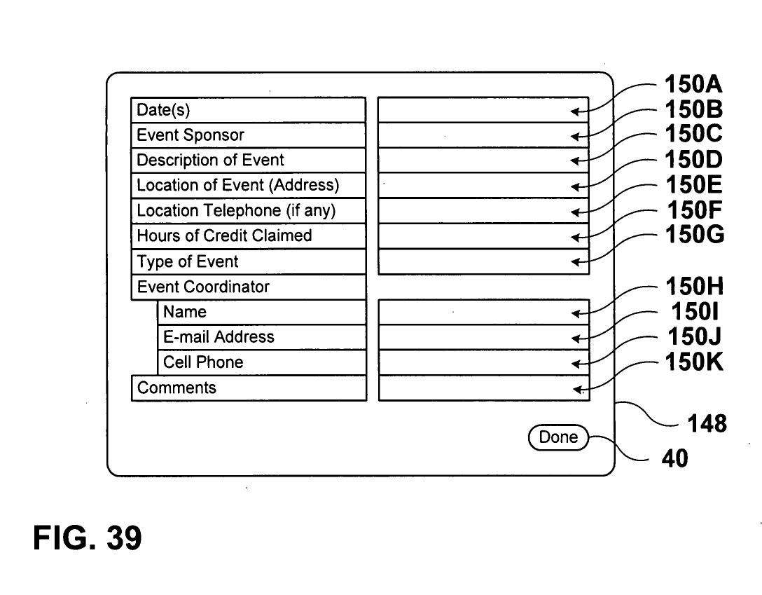

Students may participate is community service events 32 created by themselves or sponsored by organizations other than those CSOs registered on the Web site. A student 24 may get credit for those community service hours and have them tracked using the Web site by clicking button 146 on their home page 30U and uploading information about the event. Clicking button 146 brings up popup box 148 through which the student 24 may provide information about the event 150. See FIG. 39.

The student 24 enters the date(s) of the event 150A, the event sponsor 150B, a description of the event 150C, the location of the event 150D, the location telephone number 150E, the hours of community service hours claimed 150F, the type of event 150G, the name of the event coordinator or other responsible person 150H, their e-mail address 1501 and cell phone number 150J, and any comments about the event 150K. Clicking button 40 will enter the information about the event 150 into the Web site and then close popup box 148. Once the information is entered into the Community Service Reconciliation System 10A, all of the notifications and other functions of the invention apply to event 32, including the requirement to complete an event evaluation form 66.

There are a plurality of business models for the invention. The simplest model is a fee for services. A community service organization 26, for example, might pay a fee per event it wishes to register. Alternatively, a CSO 26 might pay a monthly or annual fee independent of the number of events registered.

A school 28 might pay a monthly fee or a fee per student registered on the Web site 30 to get access to the event evaluations and the tracking of student 24 community service hours.

A student 24 might pay a monthly fee or a fee for each event for which they register.

An alternative business model for the invention is the freemium model. For example, CSO events 32 might be listed and students may register for these events without charge. Students 24 would, however, have to pay a fee to have their event evaluation forms 66 transmitted to their school 28, completion and submission of the evaluation form 66 being a prerequisite for getting credit for the community service hours.

One embodiment of a business model for commercially implementing the invention is an advertising supported model as shown in FIG. 27. Section 102E of the student's home page 30U shown in FIG. 27 is a banner advertisement. A bank, for example, could be interested in securing a banner advertisement 102E on a student's home page 30U as a way of attracting students in school for their first banking relationship.

Section 102F of the student's home page 30U comprises sponsored advertisements like those that appear on Google®. Advertisements might be sponsored, for example, by a community service organization 26 or a college seeking to attract students 24 to consider attending there.

Section 102G of the student's home page 30U comprises special offers that could be associated with participation in a community service event 32. For example, Groupon® might offer a discount to a restaurant in proximity to a community service event 32 if the students eat there before or after the event, or Quicksilver® might offer a discount on the purchase of a special item of clothing associated with a community service event 32 or school 28.

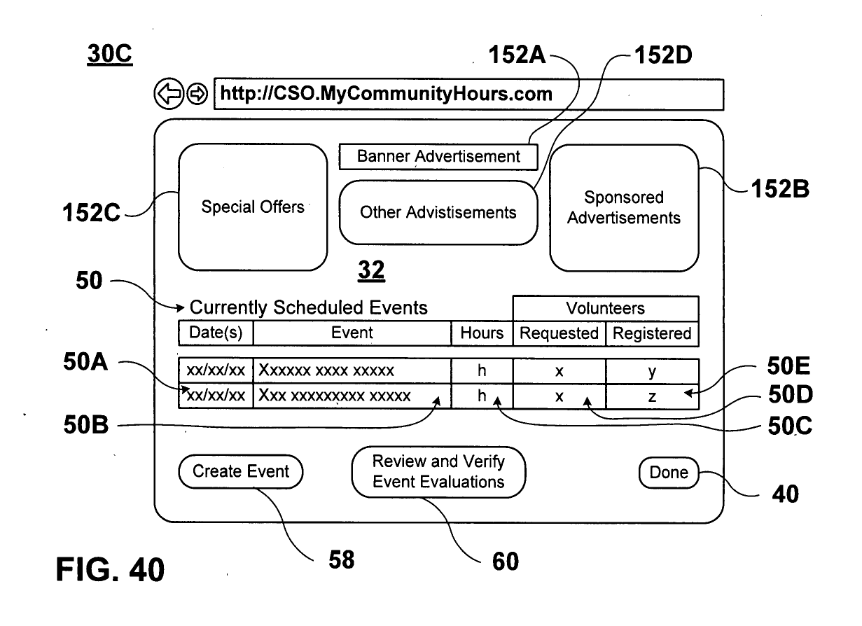

One embodiment of the invention extends the advertising supported model to suppliers to community service event sponsors, the community service organizations 26. FIG. 40 shows an alternative embodiment of the CSO home page 30. This embodiment of a CSO home page 30C includes a banner advertisement 152A, sponsored advertisements 152B, special offers 152C and other advertisements 152D.

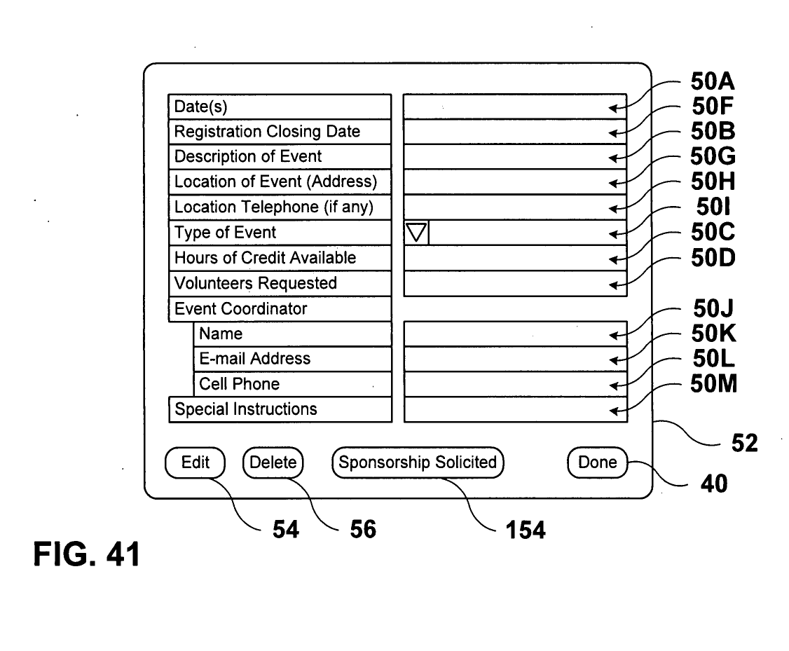

In a further embodiment of the invention, when a CSO creates a community service event 32, it may offer sponsorship opportunities for that event. For example, a CSO may allow an advertiser to place banners at the site of a community service event 32 in return for paying a portion of the cost of putting on the event. Clicking button 154 on popup box 52 announces that sponsorships are solicited for the community service event 32 being created by sending announcement messages to potential sponsors. See FIG. 41. Potential sponsors may include advertisers 152 and other community service organizations 26.

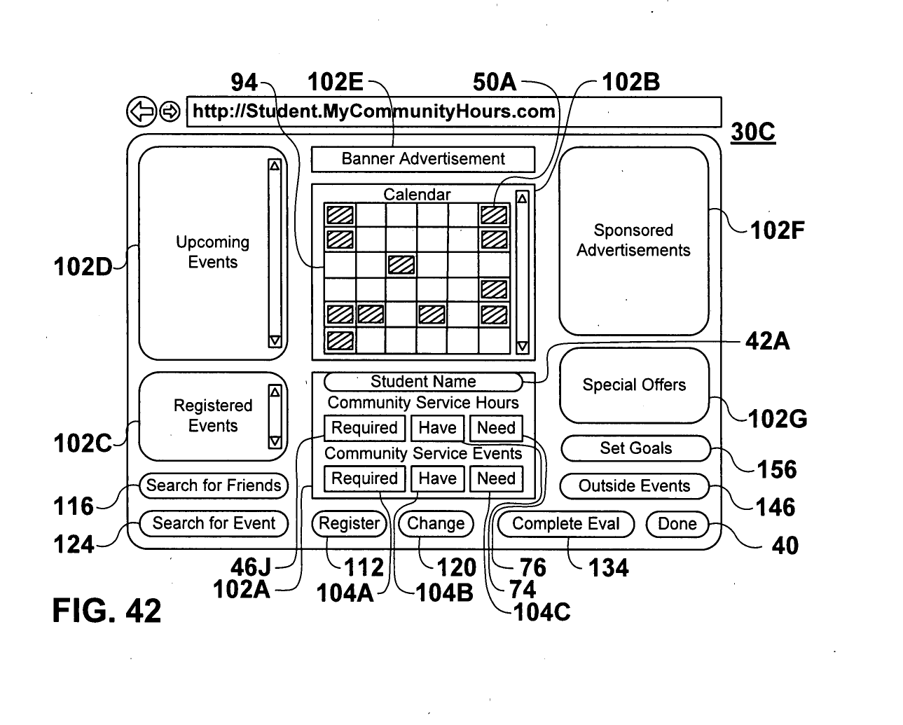

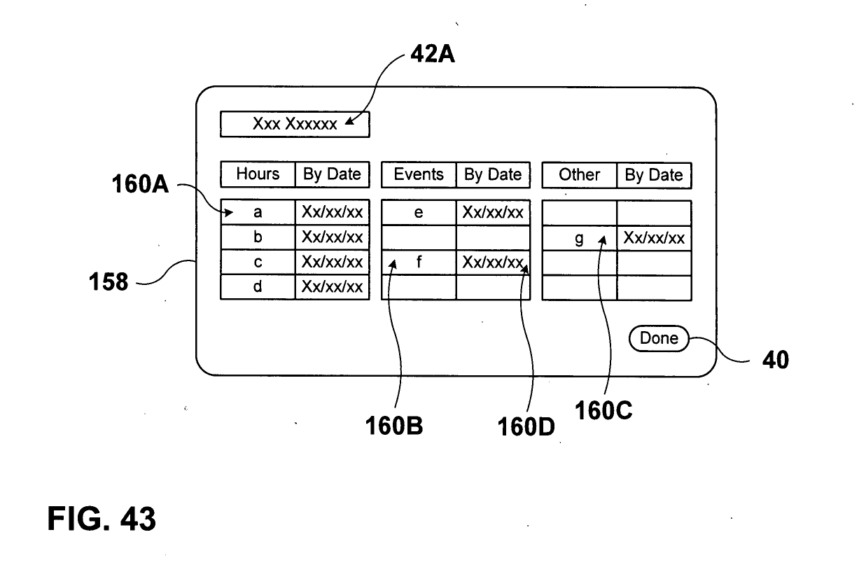

To encourage and reward participation in community service events, one embodiment of the invention includes an achievement system. In one embodiment a student 24 sets community service participation goals for himself or herself and the Web site tracks their progress towards meeting those goals. Clicking button 156 on a student's home page 30U shown in FIG. 42 brings up popup box 158 that allows the student 24 to enter community service goals 160, as shown in FIG. 43. Goals may include community service hours 160A, number of events 160B, or other measures 160C, all by certain dates 160D.

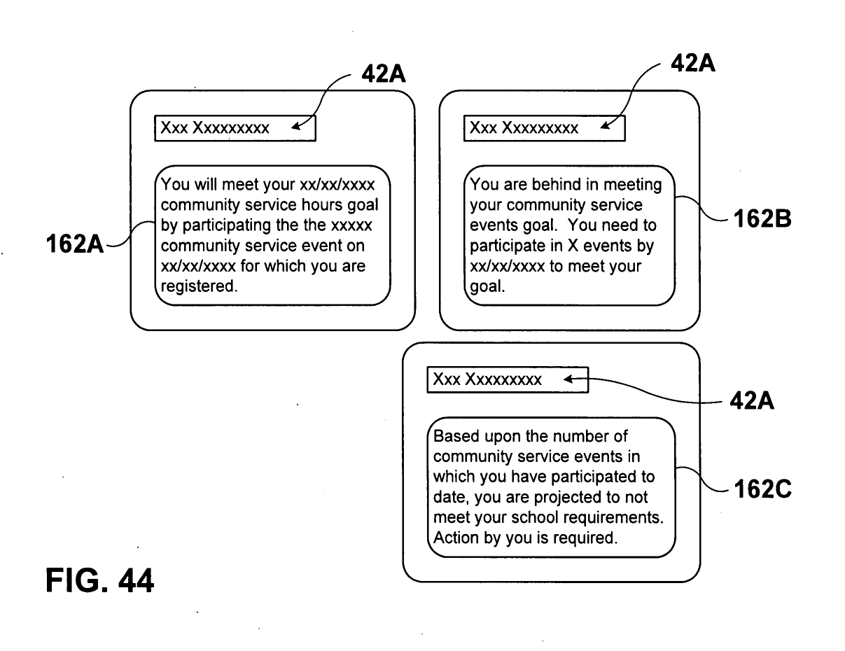

The disclosed invention will track a student's 24 performance against these goals 160 and inform the student of his or her progress. Examples of two goal tracking messages 162 are shown in FIG. 44. Message 162A tells the student 24 that they will meet a specific hours goal 160A by participating in a specific event 32 for which the student is already registered 60A. Message 162B tells the student 24 they are behind in meeting their community service events goal 160B.

In a further embodiment, the invention may also project a student's success in reaching their goals 160 or meeting their school requirements 46J based upon their past participation in community service events 32. Message 162C in FIG. 44 tells the student 24 they are projected not to meet their community service goals 160 or their school requirements 46J and that action by the student 24 is required.

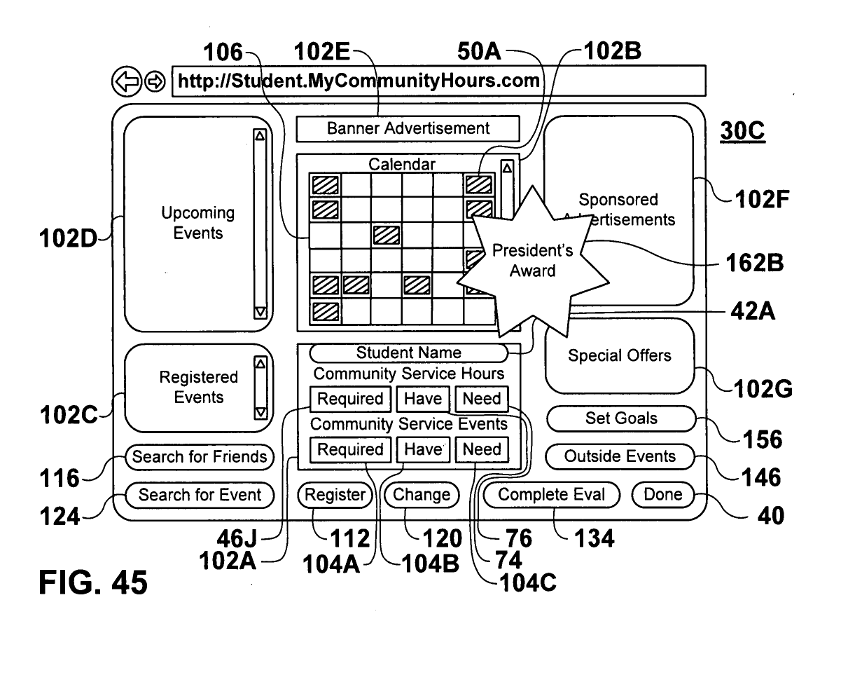

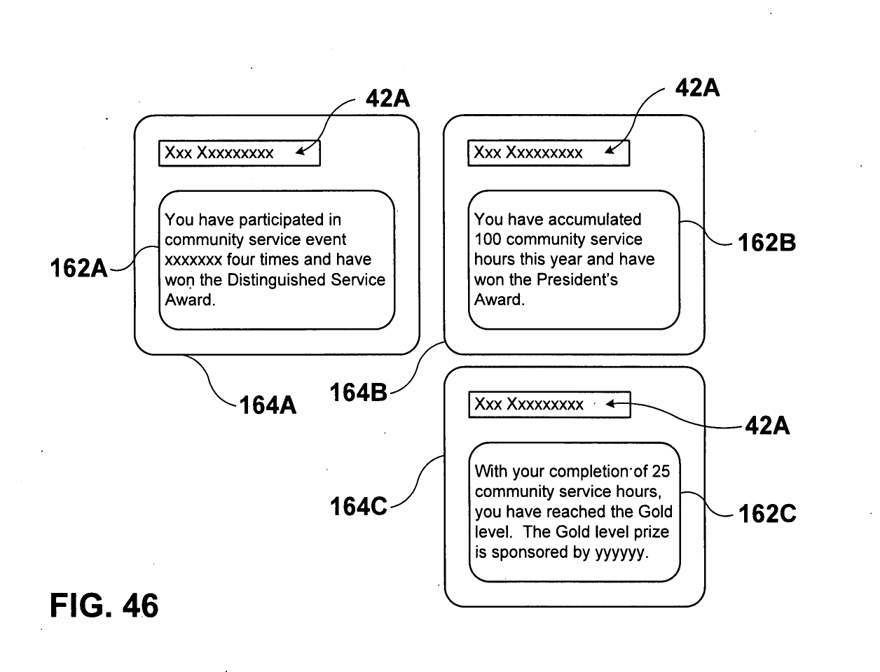

A further embodiment of the invention establishes achievement awards 164 for participation in community service events 32. For example, there may be an award 164A for participating in a particular community service event 32 multiple times, or an award 164B for reaching a certain number of community service hours, or awards 164C for levels of community service hours such as Gold, Silver and Platinum. These awards may be evidenced on a student's home page 30U as shown in FIG. 45. Alternatively, the awards may be noted in messages 166 to students 24 and their schools 28 as shown in FIG. 46. The messages 164A-C correspond to the awards 162A-C described above.

The awards 164 may be sponsored by advertisers or others, as is shown in message 164C in FIG. 46.

### II. Intelligent Match System

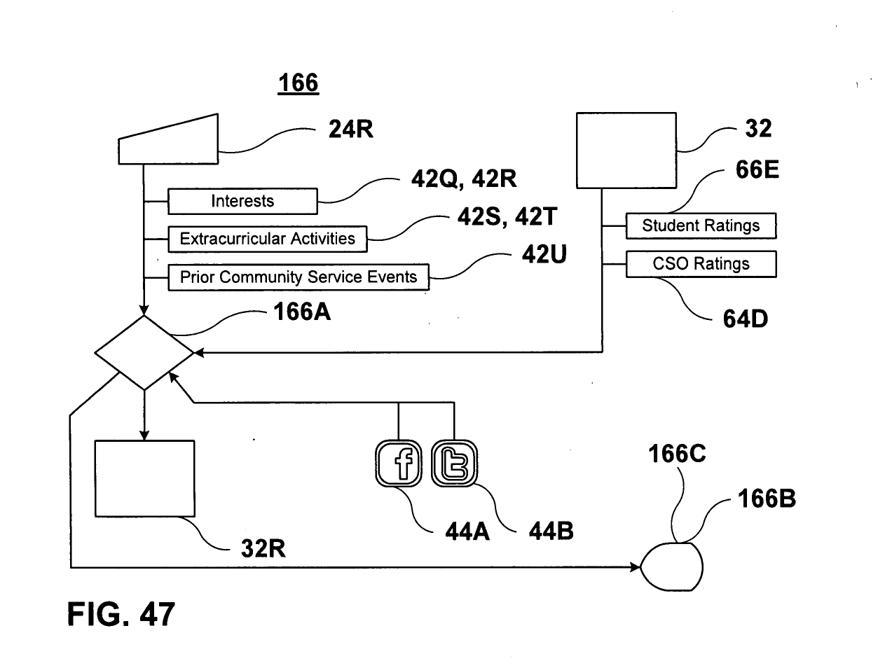

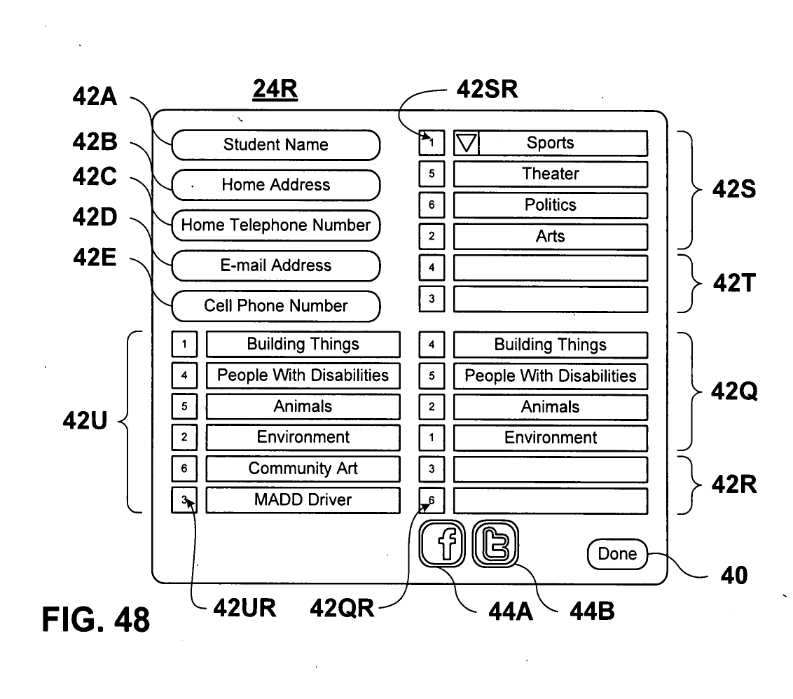

One embodiment of the Community Service Reconciliation System 10A includes an Intelligent Match System (“IMS”), which matches students 24 with CSO events 32 based upon a plurality of inputs and factors. An embodiment of an IMS 166 is shown in FIG. 47. At the time a student 24 registers on the Web site 24R he or she ranks his or her interests 42QR, as shown in FIG. 48. FIG. 48 is an alternative embodiment of FIG. 12. A student also lists his or her extracurricular activities 42S and 42T and ranks them 42SR. A student also lists prior community service events 42U and ranks them 42UR. These inputs, interests 42Q, 42R, extracurricular activities 42S, 42T, and prior community service events 42U may be used to recommend CSO events 32R that might be of interest to the student 24 via an event recommendation selection means 166A.

One embodiment of an event recommendation selection means 166A is to add up the rankings 42QR, 42SR, 42UR and recommend events comprising the lowest numerical characteristics. For example, in the embodiment shown in FIG. 48, “environment” is ranked 1^{st} in interests 42Q, not ranked in extracurricular activities 42S, 42T, and ranked 2^{nd} in prior community service events 42U. A CSO event 32 focused on “environment” would have a total score of 3, of more interest to this student than “people with disabilities” that has a total score of 9.

After a student 24 participates in a CSO event 32, he or she has the opportunity to rate the event 66E. One embodiment of a rating means 66E is a one to five scale such as:
“5” “Blew my mind. I could do this every day for the rest of my life.”
“4” “Really great event that I would like to do again.”
“3” “Pretty good event. I would probably do it again, but I will look for some other events more to my interests.”
“2” “Ok, but not my thing. Not worth doing again.”
“1” “Not for me; I would not do this again.”
   Similarly, a CSO representative 26A rates the participation of the student in an event 64D. One embodiment of a rating means 64D is a one to five scale such as:
“5” “Above and beyond any expectation. I would adopt this student if I could.”
“4” “Did everything expected and more than was asked.”
“3” “Did a satisfactory job; a positive contributor but nothing special.”
“2” “Below expectations. Did the bare minimum or less; did not want to be here.”
“1” “Did not show up, or it could have been better if the student had not shown up.”
   These rankings may be input into the event recommendation selection means 166A and contribute towards revised recommended events 32R. One embodiment of how these ranking may be added to the event recommendation selection means 166A is to invert the order of the rankings 64D, 66E and add them to the 42QR, 42SR, 42UR rankings. Recommend events comprising the lowest numerical characteristics would be recommended.

If the student uses Facebook® 44A and/or Twitter® 44B and/or social media, the event recommendation selection means 166A may reflect data from the social media. For example, events 32 for which a student's friends 42K have registered would increase the attractiveness of a recommended event 32R. To the extent that friends 42K “like” CSOs 26 or CSO events 32 on Facebook can also influence the event recommendation selection means 166A. Similarly, people that a student 24 “follows” on Twitter, or CSOs 26 that the student 24 or his or her friends 42K “follow” can also influence the event recommendation selection means 166A. Additionally, posts on a “community service” page on Twitter can influence the event recommendation selection means 166A.

A numerical embodiment of the intelligent match system 166 may be used to predict the prospective attractiveness of a particular CSO event 32 to a student 24, and can influence a recommendation 32R. For example, if a student 24 attempts to register for a particular event 32 and the student 24 has previously received a low evaluation rating 64D from that CSO 26 and the event 32 is low on the student's 24 preference list 42Q, 42R, the intelligent match system 166 may generate a message 166B to the student 24 recommending other events 32R.

A further numerical embodiment of the intelligent match system 166 may highlight differences between a student's overall rating of an event 32, 32R with a measure of other student's ratings of the event 32, 32R. For example, a significant difference between the student's overall rating of an event 32, 32R and the average rating of all of the student's who participated in the event 32 or to whom the event has been recommended 32R could result in a message 166C to the student 24 asking for additional information about the event 32, 32R or their reactions to it.

### III. Alternative Embodiment of the Disclosed Invention

An alternative embodiment of the Community Service Reconciliation System 10A includes internships 168 along with community service events 32. The primary embodiments of the Community Service Reconciliation System 10A are focused on community service events 32 that result in students 24 receiving hours 74 or events 104B credits for discrete events. The functionality of the Community Service Reconciliation System 10A may be expanded to encompass internships 168 in both CSOs 26 and public and private organizations 170. Available internships 168 would be displayed in the same way as events 32. When a student 24 applied for an internship 168, the student's application 168A would be sent to the CSO 26 or the public or private organization 170 for consideration.

### IV. Further Embodiment of the Disclosed Invention

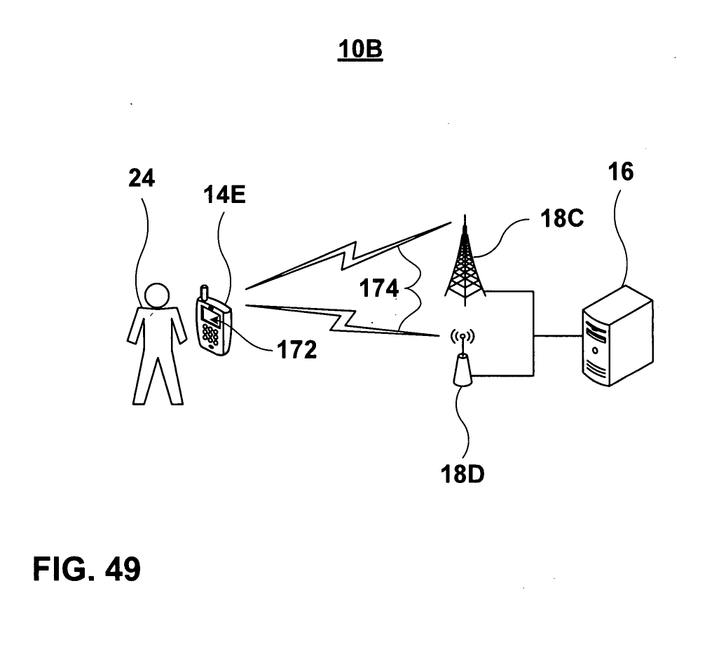

A student's 24 life today is inherently tied to a Smart Phone 14E; almost every student 24 has one and they use if for everything, contacting friends and parents, doing homework, tracking class assignments, playing games, and many other activities. A further embodiment of the Community Service Reconciliation System 10B is shown in FIG. 49, in which the information on the Web site 30 is contained in an application 172 that may be downloaded 174 to an information appliance 14. In the specific embodiment shown in FIG. 49, the information appliance 14 is a student's 24 Smart Phone 14E.

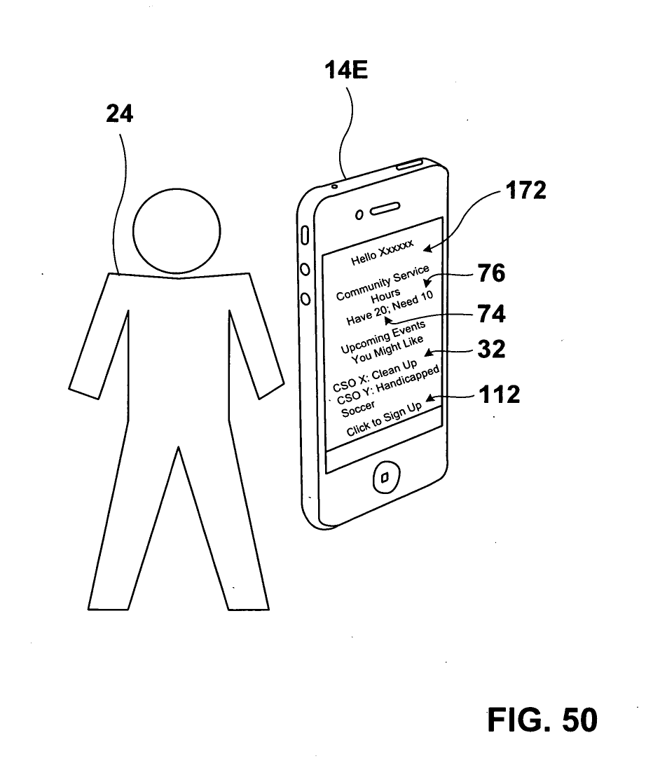

FIG. 50 illustrates the application 172 on a Smart Phone 14E. The embodiment in FIG. 50 show the number of community service hours the student 24 has 74, and the number he or she needs 76. It also lists some community service events 32 that might be of interest to the student 24, with an opportunity to register 112 for them.

### CONCLUSION

Although the present invention has been described in detail with reference to one or more preferred embodiments, persons possessing ordinary skill in the art to which this invention pertains will appreciate that various modifications and enhancements may be made without departing from the spirit and scope of the Claims that follow. The various alternatives that have been disclosed above are intended to educate the reader about preferred embodiments of the invention, and are not intended to constrain the limits of the invention or the scope of Claims.

### LIST OF REFERENCE CHARACTERS

10 Community Service Reconciliation System
12 User of a Community Service Reconciliation System
14 Information appliance
14D Cell phone
14E Smart Phone
14F Personal computer (PC)
14G Laptop computer
14H Personal Digital Assistant (PDA)
14I Tablet
14J Gaming device
14M Information appliance memory
14P Information appliance processor
14S Information appliance application software
14Z Information appliance display or interface
14Z1 Student information appliance display or interface
14Z2 Community service organization representative information appliance display or interface
14Z3 School representative information appliance display or interface
16 Server
16M Server memory
16P Server processor
16S Server software
18 Communications network
18A Wired telephone network, plain old telephone network (POTS)
18B Ethernet
18C Cellular network
18D Wireless Fidelity, Wi-Fi, network, Institute of Electrical and Electronics Engineers' (IEEE) 802.11 standards
20 Input data
22 Output data
24 Student
26 Community service organization (CSO)
26A Community service organization representative
28 School
28A School representative
30 Web site
30A First Web site screen
30C Community service organization Web site home page
30S School Web site home page
30U Student Web site home page
32 Community service organization event
32R Recommended community service organization event
34 Community service event
36 Community service organization registration data
36A Community service organization name
36B Community service organization address
36C Community service organization telephone number
36D Community service organization facsimile number
36E Community service organization electronic mail address
36F Community service organization Web site Uniform Resource Locator
36G Community service organization primary contact name
36H Community service organization primary contact telephone number
36I Community service organization primary contact electronic mail address
36J List of Zip Codes in which the community service organization holds events
36K Community service organization registered user name
36L Community service organization registered user login name
36M Community service organization registered user login password
36N Community service organization registered user cell phone number
36O Community service organization registered user electronic mail address
38 Add user button
40 Done button
42 Student registration data
42A Student name
42B Student home address
42C Student home telephone number
42D Student electronic mail address
42E Student cell phone number
42F Student login name
42G Student login password
42H Student school name
42I Student graduation year
42J Student social media screen name(s)
42K Student friends
42L Student parent name
42M Student parent telephone number
42N Student parent electronic mail address
42O Student parent login name
42P Student parent login password
42Q Student activity preferences
42R Student defined activity preferences
44 Social media links
44A Facebook
44B Twitter
46 School registration data
46A School name
46B School address
46C School telephone number
46D School facsimile number
46E School electronic mail address
46F School Web site Uniform Resource Locator
46G School primary contact name
46H School primary contact telephone number
46I School primary contact electronic mail address
46J School community service hour requirements
46K School registered user name
46L School registered user login name
46M School registered user login password
46N School registered user cell phone number
46O School registered user electronic mail address
48 Login button
50 Status of currently scheduled events on a community service organization Web home page
50A Date of a currently scheduled community service organization event
50B Description of a currently scheduled community service organization event
50C Flours of credit available in a currently scheduled community service organization event
50D Number of volunteers requested for a currently scheduled community service organization event
50E Number of volunteers registered for a currently scheduled community service organization event
50F Community service event registration closing date
50G Location of a community service event, including its address
50H Telephone number of the location of a community service event
50I Type of community service event pull down menu
50J Community service event coordinator name
50K Community service event coordinator electronic mail address
50L Community service event coordinator cell phone number
52 Community service event popup box
54 Edit community service event button
56 Delete community service event button
58 Create community service event button
60 Review and verify community service event evaluation forms button
62 Community service event evaluation form popup box showing status of student participation in event(s)
64 Status of student participation in an event
64A Student that registered to participate in an event
64B Student that participated in an event
64C Community service hours for participation
64D Community service event coordinator evaluation of student participation in event
64E Event evaluation form completed
64F Community service organization representative digital signature
64G Notes concerning student participation in event
66 Event evaluation form
66A Description of the service project
66B Question: “How did your service benefit the community or organization you served?”
66C Question: “How did your service benefit you personally?”
66D Community service hours claimed
66S School proprietary event evaluation form
66SB Button to upload school proprietary event evaluation form
68 Community service event evaluation form popup box
70 Apply digital signature button
72 School Web site home page sections
72A School Web site home page alerts and warnings section
72B School Web site home page status and statistics section
72C School Web site home page search bar
74 Student accumulated community service hours
76 Student deficit community service hours
78 Message to student popup box
78A Message to student
80 Send button
82 Class year
82A Class year community service hours
82B Class year cumulative community service hours
84 Search by class popup box
86 Search by student popup box
88 Completed community service event
88A Date of completed community service event
88B Description of completed community service event
90 Search by community service organization popup box
92 Search by community service event popup box
94 School registered students not registered on Web site popup box
96 Link to Web site student registration Web page
98 Message to school registered students not registered on Web site
100 Button to send link and registration message to students not registered on Web site
102 Sections of student's home page
102A Student's community service status section of student's home page
102B Calender section of student's home page
102C Registered events section of student's home page
102D Upcoming events section of student's home page
102E Banner advertisement section of student's home page
102F Sponsored advertisement(s) section of student's home page
102G Special offers section of student's home page
104A Number of required community service events
104B Number of community service events in which the student has participated
104C Number of remaining required community service events
106 Calendar
108 Event description popup box
110A Number of students registered for the community service event
110B Number of additional students that may register for the community service event
112 Register for event button
114 Community service organization event registration popup box
116 Search for events for which friends have already registered button
118 Events for which friends have already registered popup box
120 Change event button
122 Change community service event registration popup box
124 Community service event search bar
126 Search popup box
128 Search query items
128A Event name or description
128B Event date
128C Community service organization
128D Interest area
128E Zip Code of event
128F Distance from student's home address to community service event
128G Events for which friends have already registered
130 Search results box
130A “No events match” search criteria box
130B Events meeting search criteria box
132 Search again button
134 Complete community service event evaluation form button
136 Parent of student
136L Parent login
136LN Parent login name
136LP Parent login password
136LR Parent registration button
138 Event registration reservation popup box
140 Student(s) selected to participate in a particular community service event
142 Button to notify students whether their registration for a particular community service event has been accepted or not
144 Messages to students whether their registration for a particular community service event has been accepted or not
144A Message to student that his or her registration for a particular community service event has been accepted
144B Message to student that his or her registration for a particular community service event has not been accepted
146 Button to upload information about event not sponsored by a community service organization registered on the Web site
148 Popup box through which information about a community service event not sponsored by a community service organization registered on the Web site may be uploaded
150 Information about a community service event not sponsored by a community service organization registered on the Web site
150A Date(s) of the event
150B Event sponsor
150C Description of the event
150D Location of the event
150E Location telephone number
150F Hours of community service hours claimed
150G Type of event
150H Name of the event coordinator or other responsible person
150I Electronic mail address of the event coordinator or other responsible person
150J Cell phone number of the event coordinator or other responsible person
150K Comments about the event
152 Community service organization home page advertisements
152A Community service organization home page banner advertisement
152B Community service organization home page sponsored advertisements
152C Community service organization home page special offers
152D Community service organization home page other advertisements
154 Button to solicit sponsorship of a community service event
156 Button to set community service goal
158 Community service goal popup box
160 Community service goals
160A Goal for community service hours
160B Goal for community service events
162 Messages to students about their community service goals and requirements
162A Message telling student they will meet their community service hours goal by participating in a community service event for which they are registered
162B Message telling student they will not meet their community service events unless they participate in some number of community service events by a date
162C Message telling student they are projected not to meet their school community service hours requirements
164 Messages to students about their community service awards
164A Message to a student about an award for participating in a particular community service event multiple times
164B Message to a student about an award for reaching a certain number of community service hours
164C Message to a student about an award for reaching a certain level of community service hours
166 Intelligent match system
166A Event recommendation selection means
166B Intelligent match system message with alternate recommended events 166C Intelligent match system message to student requesting additional information about an event
168 Internship
168A Student internship application
170 Public or private organization offering an internship
172 Community Service Reconciliation System application
174 Community Service Reconciliation System application download

What is claimed is:

1. An apparatus comprising:
a remote server means for providing a computing interface;
said remote server means including a memory means for storing instructions and data;
a Web site means for displaying said computing interface to a user connected to said remote server;
said Web site means being created by a software program;
said Web site means being used to match said user and a community service activity;
an information appliance means for enabling said user to view said Web site means;
said information appliance means also for enabling said user to register a community service organization on said Web site means;
said information appliance means also for registering said user on said Web site means so that said user becomes a registered user;
said Web site means also for establishing a community service status for said registered user and for storing said community service status on said remote server means;
said information appliance means also for entering said registered user's interests on said Web site means;
said plurality of events being offered for display to said registered user using said Web site means;
said Web site means also for providing a plurality of community service requirements on said Web site; said plurality of community service requirements being provided by said user's school representative;
said Web site means also for matching one of said plurality of events to one of said registered user's interests;
said Web site means also for certifying the completion of said registered user's community service requirements; and
said Web site means also for changing the status of said registered user as indicated in said memory of said remote server means.

2. An apparatus as recited in claim 1, in which
said user connects to said remote server means over a wired connection.

3. An apparatus as recited in claim 1, in which
said user connects to said remote server means over a wireless connection.

4. An apparatus as recited in claim 1, in which
said Web site means displays the status of currently scheduled events.

5. An apparatus as recited in claim 1, in which
credit for community service hours is obtained by completing an evaluation form and having it signed by a representative of the CSO.

6. An apparatus as recited in claim 1, in which
said Web site means provides a warning when a student is not meeting their community service requirements.

7. An apparatus as recited in claim 1, in which
said Web site means displays statistics concerning community service hours.

8. An apparatus as recited in claim 1, in which
said remote server means also runs software that provides a database.

9. An apparatus as recited in claim 8, in which
said Web site means is used to search said database or information regarding community service.

10. An apparatus as recited in claim 1, in which
said Web site means presents a social media button; and
clicking a social media button generates a message that informs said user's friends that he or she has registered for this community service event and inviting them to likewise register.

11. An apparatus as recited in claim 1, in which
said user's parent accesses said Web site means to monitor progress in meeting a community hours requirement.

12. An apparatus as recited in claim 1, in which
said Web site means suggests a CSO event.

13. An apparatus as recited in claim 1, in which
said software program is downloaded to a conventional Smart Phone.

14. An apparatus as recited in claim 1, in which
said Web site means generates a fee for services.

15. An apparatus as recited in claim 1, in which
said Web site means requires the payment of a freemium.

16. An apparatus as recited in claim 1, in which
said Web site means generates fees from advertising.

17. An apparatus as recited in claim 1, in which
said Web site means includes an acheivement system.

18. An apparatus as recited in claim 1, in which
provides an internship for said user.

19. An apparatus as recited in claim 1, in which
said information appliance means also for adding a list of geographic areas in which said community service organization conducts a plurality of events.

20. An apparatus as recited in claim 19, in which
said list of geographic areas being offered for display to said registered user using said Web site means.

21. A method comprising the steps of:
providing a Web site; said Web site being operated on a remote server; said remote server including a memory;
said Web site for matching an individual and a plurality of community service activities;
accessing said Web site using an information appliance;
registering a plurality of community service organizations on said Web site;
aggregating a plurality of community service organization activities on said Web site;
registering said individual on said Web site so that said individual becomes a registered user;
establishing a community service status for said registered user and storing said community service status on said remote server;
entering said registered user's interests on said Web site;
said list of geographic areas and said plurality of events being offered for display to said registered user;
providing a plurality of community service requirements on said Web site; said plurality of community service requirements being provided by said user's school representative;
matching one of said plurality of events to one of said registered user's interests;
certifying the completion of said registered user's community service requirements; and
changing the status of said registered user as indicated in said memory of said remote server.

22. A method as recited in claim 21, further comprising the step of:
adding a list of geographic areas in which said plurality of community service organizations conduct a plurality of events.
